(19) United States
(12) Patent Application Publication
(10) Pub. No.: US 2023/0281733 A1
(43) Pub. Date: Sep. 7, 2023

(54) INFORMATION PROCESSING APPARATUS FOR SMART GRID

(71) Applicant: Prime Planet Energy & Solutions, Inc., Tokyo (JP)

(72) Inventors: Kohki NAKAMURA, Okazaki-shi (JP); Katsushi SAITO, Nagakute-shi (JP); Hideyuki NAGAI, Nagaya-shi (JP)

(21) Appl. No.: 18/176,494

(22) Filed: Mar. 1, 2023

(30) Foreign Application Priority Data
Mar. 4, 2022 (JP) 2022-033687

(51) Int. Cl. G06Q 50/06; H02J 13/00; G05B 15/02; G06Q 30/0645

(52) U.S. Cl. CPC G06Q 50/06; G05B 15/02; G06Q 30/0645; H02J 13/00006; H02J 2300/22; H02J 2310/12; H02J 2310/48

(57) ABSTRACT

In the information processing apparatus, the virtually-stored electric energy amount of the one of the users stored in the first memory storage unit is configured to be arithmetically increased according to an amount of electric energy that is output from an electrical equipment unit associated with the one of the users to the smart grid and to be arithmetically reduced according to an amount of electric energy that is output from the smart grid to the electrical equipment unit associated with the one of the users.

### CROSS REFERENCE TO RELATED APPLICATIONS

The present application claims priority from Japanese Patent Application No. 2022-033687 filed on Mar. 4, 2022, which is incorporated by reference herein in its entirety.

### BACKGROUND

The present invention relates to an information processing apparatus for a smart grid.

JP 2021-118618 A discloses an energy management system capable of appropriately allocating amounts of electric power reduction target to a plurality of consumers. The energy management system disclosed in the publication includes a power generation amount predicting unit that predicts, based on meteorological information, a power generation amount of a power generating facility of each consumer in a target time slot, a demand predicting unit that predicts an electric power demand of each consumer in the target time slot, and an allocation determining unit that determines an allotment of electric power reduction amount of electric power reduction amount creation command, based on a predicted value of actual demand that is obtained by subtracting a predicted value of power generation amount from a predicted value of electric power demand.

### SUMMARY

It is an intention of the present inventors to accomplish an electricity trade with a higher degree of freedom and to improve user convenience in using electric power, in relation to electric power that utilizes renewable energy.

An information processing apparatus for a smart grid according to the present disclosure includes a first memory storage unit recording respective virtually-stored electric energy amounts of a plurality of users of the smart grid, the virtually-stored electric energy amounts being respectively associated with the plurality of users.

The first memory storage unit is configured to record the virtually-stored electric energy amount of one of the users as a positive amount according to an amount of electric energy that is greater than 0 when the virtually-stored electric energy amount of the one of the users is greater than 0, and to record the virtually-stored electric energy amount of the one of the users as a negative amount according to an amount of electric energy that is less than 0 when the virtually-stored electric energy amount of the one of the users is less than 0.

The virtually-stored electric energy amount of the one of the users stored in the first memory storage unit is configured to be arithmetically increased according to an amount of electric energy that is output from an electrical equipment unit associated with the one of the users to the smart grid and to be arithmetically reduced according to an amount of electric energy that is output from the smart grid to the electrical equipment unit associated with the one of the users.

This information processing apparatus may record a virtually-stored electric energy amount as a negative amount. Because the virtually-stored electric energy amount is recorded as a negative amount, a user is allowed to borrow electric power from the smart grid when there is a shortage of electric power, and to return the electric power after surplus electric power arises. This improves user convenience in using electric power for the users utilizing renewable energy.

The information processing apparatus may further include a second memory storage unit storing data representing at least one of electricity storage devices connected to the smart grid, the at least one of electricity storage devices being usable by the one of the plurality of users and associated with the one of the plurality of users. In this case, the virtually-stored electric energy amount of the one of the users stored in the first memory storage unit is configured to be arithmetically increased according to an amount of electric energy stored in the one of the electricity storage devices associated with the one of the users, and to be arithmetically reduced according to an amount of electric energy that is output from the one of the electricity storage devices associated with the one of the users.

A positive permissible amount may be predetermined for the virtually-stored electric energy amount of the one of the users. The information processing apparatus may be configured to execute an electricity purchasing process according to an amount of electric energy that is output from the smart grid to the electrical equipment unit associated with the one of the users when the virtually-stored electric energy amount of the one of the users falls beyond the negative permissible amount. The negative permissible amount may be determined according to an amount of electric energy that is output from the electrical equipment unit associated with the one of the users to the smart grid for a predetermined period. The negative permissible amount may be determined according to a predicted value of amount of electric energy that is output from the electrical equipment unit associated with the one of the users to the smart grid for a predetermined period.

It is also possible that a positive permissible amount may be predetermined for the virtually-stored electric energy amount of the one of the users. In this case, the information processing apparatus may be configured to execute an electricity selling process according to an amount of electric energy that is output from the electrical equipment unit associated with the one of the users to the smart grid when the virtually-stored electric energy amount of the one of the users exceeds the positive permissible amount. The positive permissible amount may be determined according to a storable capacity of one of the electricity storage devices connected to the smart grid, the one of the electricity storage devices being usable by the one of the users.

The information processing apparatus may be configured to record lending and borrowing of the virtually-stored electric energy amount between the plurality of users of the smart grid. In this case, the information processing apparatus may be configured to set an interest for the lending and borrowing of the virtually-stored electric energy amount. The information processing apparatus may be configured to record data of the virtually-stored electric energy amounts of the plurality of users in a blockchain.

### BRIEF DESCRIPTION OF THE DRAWINGS

FIG. 1 is a schematic view illustrating a smart grid 10.

FIG. 2 is a schematic view of an information processing apparatus 100 for the smart grid 10.

FIG. 3 is a configuration diagram illustrating an example of the configuration of a memory storage unit that stores virtual electrical storage capacities in association with users.

FIG. 4 is a table illustrating an example of the configuration of a memory storage unit that stores information indicative of power generation devices 51 to 55 in association with users.

FIG. 5 is a table illustrating an example of the configuration of a memory storage unit that stores data representing electricity storage devices 61 to 65 in association with users.

FIG. 6 is a schematic view illustrating processes m51 and m52, each of which is an example of purchasing process m5.

FIG. 7 is a schematic view illustrating processes m61 and m62, each of which is an example of selling process m6.

FIG. 8 is a schematic view illustrating another embodiment of a table that is recorded in a first recording process m1.

FIG. 9 is a schematic view illustrating a system that is implemented by a second recording process m11 and a sharing setting process m12.

FIG. 10 is a schematic view illustrating an example of the configuration of a smart grid 10 including an information processing apparatus 140 disclosed herein.

FIGS. 11A-C are tables illustrating an example of simulation data showing the transition of electric power supply and demand of a user.

FIGS. 12A-C are tables illustrating another example of simulation data showing the transition of electric power supply and demand of the user.

FIGS. 13A-C are tables illustrating another example of simulation data showing the transition of electric power supply and demand of the user.

FIGS. 14A-C are tables illustrating another example of simulation data showing the transition of electric power supply and demand of the user.

### DETAILED DESCRIPTION

Embodiments of the present disclosure will be described hereinbelow. It should be noted, however, that the embodiments illustrated herein are, of course, not intended to limit the disclosure. The present disclosure is not limited to the following embodiments described herein unless specifically stated otherwise. The drawings are depicted schematically and do not necessarily accurately depict actual objects. The features and components that exhibit the same effects are designated by the same reference symbols as appropriate, and the description thereof will not be repeated.

### Smart Grid 10

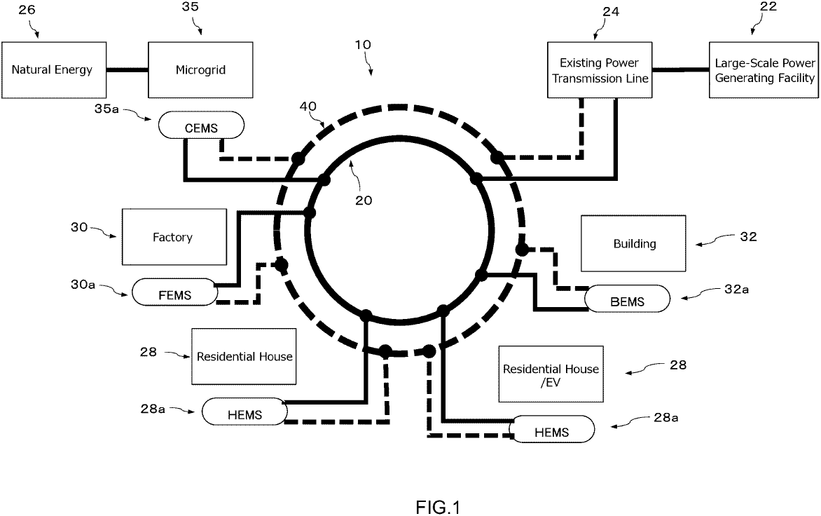

FIG. 1 is a schematic view illustrating a smart grid 10. As illustrated in FIG. 1, the smart grid 10 includes a transmission grid 20 and a communication network 40. A plurality of electrical equipment units are connected to the transmission grid 20 of the smart grid 10. Herein, the term “electrical equipment unit” collectively refers to various types of equipment that are necessary to use electricity. The electrical equipment units may include various types of equipment that are used for electric power generation, conversion of electric energy into another form of energy, electricity storage, voltage conversion and power factor regulation, connection and disconnection of electric power, and the like. The transmission grid 20 of the smart grid 10 is connected to various types of electrical equipment units, including: existing power transmission lines 24 for transmitting electric power from a large-scale power generating facility 22, such as a thermal power plant, a hydroelectric power plant, and a nuclear power plant, that is operated by a power utility company; a power generation operator 26 that uses natural energy, such as solar power generation and wind power generation; a residential house 28 installed with a solar power system or a cogeneration power generation system; a factory operator 30 installed with a solar power system on a factory; and a building operator 32 installed with a solar power system on a building. The transmission grid 20 may also be connected to electric vehicles equipped with on-board batteries. Each of small-scale independent regional grids that include a solar power generation plant and a wind power generation plant may be considered as a small-sized electric power distribution grid, which is referred to as a microgrid 35. Each of these electricity consumers and power generation operators connected to the transmission grid 20 of the smart grid 10 is connected to a communication network 40 so that data of the electric power transmission and distribution can be bidirectionally communicated with each other and can be managed.

Herein, electric vehicles that are connectable to the transmission grid 20 include various types of electric vehicles that are connected to the transmission grid 20 and are capable of charging and discharging, such as plug-in hybrid electric vehicles (PHEVs), plug-in range extender electric vehicles (RexEVs), fuel cell electric vehicles (FCEVs), and battery electric vehicles (BEVs). The electric vehicles may also include hybrid electric vehicles (HEVs), range extender electric vehicles, and fuel cell electric vehicles, each provided with the function to be connected to the transmission grid 20 and supply electric power generated by the vehicles to the transmission grid 20. The hybrid electric vehicles and the range extender type electric vehicles may include not only ones that generate electric power using gasoline or diesel fuel but also ones that generate electric power with a hydrogen engine.

The electricity consumers are those who consume electric power, such as households and factories. The electricity consumers receive supply of electricity while purchasing electricity when appropriate. The power generation operators that make use of natural energy such as solar power generation and wind power generation sell the generated electric power. The business operators installed with a solar power generation equipment on their own factories or buildings, the electricity consumers that perform home power generation, and the like sell electricity when surplus electric power arises in the solar power generation equipment and purchase the electric power that cannot be covered by the solar power generation equipment.

Among them, a management system 28a within a household is referred to as a home energy management system (HEMS). A management system 30a within a factory is referred to as a factory energy management system (FEMS). A management system 32a within a building is referred to as a building energy management system (BEMS). An energy management system 35a of the microgrid 35 that manages the electric power demand in a region and the amount of electric power supply supplied by regional power plants such as solar power generation plants, wind power generation plants, and biomass power generation plants is referred to as cluster/community energy management system (CEMS). CEMS is a vital system of the smart grid, which manages the overall energy of the region including HEMS, BEMS, and FEMS. The smart grid 10 is installed with an information processing apparatus 100 that collects information from these elements. The smart grid 10 is configured to be able to control and optimize the flow of electric power in the transmission grid 20 from both supply side and demand side by utilizing information technology through the communication network 40.

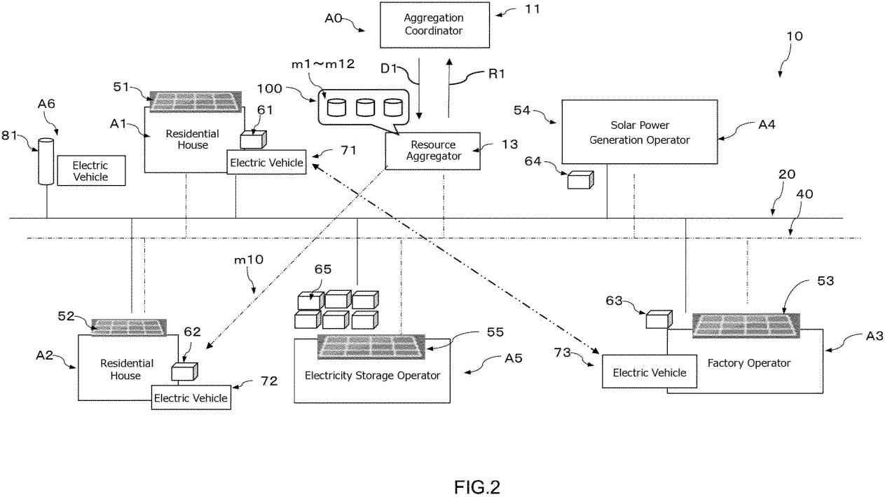

FIG. 2 is a schematic view of an information processing apparatus 100 for the smart grid 10. The smart grid 10 may include, as illustrated in FIG. 2, an aggregation coordinator 11 and a resource aggregator 13. The aggregation coordinator 11 is a business operator that aggregates the amount of electric power controlled by the resource aggregator 13 and directly engages in electric power transactions with general transmission-and-distribution operators and retail electric providers. The aggregation coordinator 11 is served by, for example, a power utility company. The resource aggregator 13 is generally a business operator that directly makes VPP service agreements with consumers of electric power to control the resources.

As illustrated in FIG. 2, the aggregation coordinator 11 requests the resource aggregator 13 to perform control for adjusting demand according to demand response (D1). The resource aggregator 13 responds to such a control request according to the agreement with the aggregation coordinator 11 (R1). The adjustments that are required of the resource aggregator 13 are two types, “downward DR” in which electric power demand is reduced (i.e., suppressed) and “upward DR” in which electric power demand is increased (i.e., created). In the downward DR, for example, the HEMS, the BEMS, and the FEMS (see FIG. 1) are controlled to reduce the electric power consumption. In cases where there are electricity storage devices and electric vehicles that are connected to the transmission grid 20 so as to be able to output electric power thereto, the downward DR may be performed to control the electricity storage devices and the electric vehicles to supply the electric power stored in the electricity storage devices and the electric vehicles to the transmission grid 20. In the upward DR, for example, the HEMS, the BEMS, and the FEMS are controlled to increase the electric power consumption. For example, the BEMS may be effected to cancel the control for lowering the temperature setting of the air conditioning. It is also possible that the FEMS may be used to increase the utilization rate of the factories. In cases where there are electricity storage devices and electric vehicles that are connected to the transmission grid 20 so as to be able to output electric power thereto, the upward DR may be performed to control the electricity storage devices and the on-board batteries of the electric vehicles to actively store electric power in the electricity storage devices and the electric vehicles.

Currently, interchange of electric power is processed each time with sales of electricity and purchases of electricity. The electric power supplied to the transmission grid 20 is the one that is sold, while the electric power received from the transmission grid 20 is the one that is purchased. In the case of, for example, the residential house equipped with solar power generation equipment and an electricity storage device, electricity is sold each time when there is surplus electric power in the solar power generation equipment such as to exceed the electricity storage capability of the electricity storage device. During night time or when weather is poor, for example, there may be cases where sufficient electric power is not stored in the electricity storage device or the output capacity of the electricity storage device is limited so that the output power from the electricity storage device alone is insufficient to supply the power consumption of the household. In such cases, the user needs to purchase the shortfall amount of electric power each time. However, if it is possible to use the electric power generated by the solar power generation equipment installed in the residential house all the time, the solar power generation equipment may be able to supply all the electric power consumed by the household, or it may be possible to reduce the amount of electric power that needs to be purchased. In addition, the sales of electricity is the act in which electric power is exchanged into money, whereas the purchase of electricity is the act in which electric power is bought with money. Because these acts involve money, a monetary loss may arise due to the difference between the electricity sales price and the electricity purchase price. The present inventors intend to construct a system that allows users to feel that they have consumed the maximum amount of electric power generated at their own houses even in such cases.

The information processing apparatus 100 of the smart grid 10 proposed herein is, as illustrated in FIG. 2, connected to the communication network 40 of the smart grid 10. The smart grid 10 includes a transmission grid 20 connected to a plurality of power generation devices 51 to 55 and a plurality of electricity storage devices 61 to 65, and a communication network 40 transmitting at least the information on the amount of electric energy transmitted through the transmission grid 20.

In the example shown in FIG. 2, the power generation devices 51 to 55 may include various types of power generation devices, such as a solar power generation device, a cogeneration power generation device, a wind power generation device, and a biomass power generation device. The power generation devices 51 to 55 may also include home-use power generation devices and large-scale power generation devices, for example.

The electricity storage devices 61 to 65 may include various types of electricity storage devices, such as stationary-type electricity storage devices and on-board batteries of electric vehicles that are connectable to the smart grid 10. The stationary-type electricity storage devices may also include home-use stationary-type electricity storage devices and large-scale electricity storage devices, for example.

In the example shown in FIG. 2, the electricity storage devices 61 and 62 are home-use stationary-type electricity storage devices installed in residential houses A1 and A2. The residential houses A1 and A2 are provided with charging and discharging stations to which electric vehicles 71 and 72 can be connected when appropriate. Each of the electric vehicles 71 and 72 includes an on-board battery that is capable of being charged and discharged through the charging and discharging stations. Thus, each of the electric vehicles 71 and 72 functions as an electricity storage device as appropriate. In addition, solar panels serving as the power generation devices 51 and 52 are installed on the rooftops of the residential houses A1 and A2. The residential houses A1 and A2 may be stand-alone houses, or multi-family residential houses, such as condominiums and apartment houses.

A factory A3 is equipped with a power generation device 52 that utilizes renewable energy, such as a solar panel, and a stationary-type electricity storage device 63. In the example shown in FIG. 2, the factory A3 is provided with a charging station. For example, an electric vehicle 73 of an employee who commutes by electric vehicle is connected to the charging station. Here, during work hours, the employee’s electric vehicle 73 is connected to the smart grid 10 via the charging station in the factory A3. During home hours, the employee’s electric vehicle 73 is connected to the smart grid 10 via a charging station installed in his/her residential house.

For example, the resident of a residential house A1 may be an employee of the factory A3. In this case, it is possible that the resident of the residential house A1 commutes to the factory A3 by an electric vehicle 71. The electric vehicle 71 may be connected to the smart grid 10 at the residential house A1 and at the factory A3 as appropriate. For this reason, even on weekdays, the electric vehicle 71 is connected to the smart grid 10 most of the time during the time slot in which it is parked. The electric vehicles 71 to 73 may be connected to the smart grid 10 via a charging station 81 of charging spots A6 that are provided not only at residential houses and the workplaces but also at commercial facilities, tourist spots, and regional areas. Also, the charging spot A6 and the electric vehicles 71 to 73 may be configured to have a function of controlling charging from the smart grid 10 and discharging to the smart grid 10 appropriately. The charging from the smart grid 10 and the discharging to the smart grid 10 may be controlled by, for example, the resource aggregator 13.

A power generation operator A4 is equipped with a power generation device 54 installed with a large number of solar panels. The power generation operator A4 allows the electric power generated by the solar panels to be discharged to the smart grid 10. The power generation device of the power generation operator A4 is not limited to the solar power generation device but may be various types of power generation devices, such as wind power generation devices, biomass power generation devices, and small-sized hydroelectric power generation devices. The power generation operator A4 may be provided with an appropriate stationary-type electricity storage device 64. An electricity storage operator A5 is a business operator that prepares a large-scale electricity storage equipment 65 installed with a large number of electricity storage devices. In the embodiment shown in FIG. 2, the facility of the electricity storage operator A5 is also provided with a power generation device 65 such as solar panels. The large-scale electricity storage equipment 65 prepared by the electricity storage operator A5 may be, for example, a stationary-type storage battery in which recycled products of on-board vehicle batteries, off-specification products from battery manufacturers, and the like are combined. Such a stationary-type storage battery is considered to be able to construct a high-capacity and stable storage battery at relatively low cost.

The higher the total capacity of all the electrical storage devices connected to the smart grid 10 is, the higher the degree of flexibility in electricity storage. The total capacity of all the electrical storage devices connected to the smart grid 10 may be, for example, higher than or equal to an electricity storage capacity corresponding to the electric power required by the microgrid in half a day, more preferably higher than or equal to an electricity storage capacity required in two or three days, and still more preferably higher than or equal to an electricity storage capacity required in a week. Moreover, all the electrical storage devices may desirably be charged sufficiently. Furthermore, all the electrical storage devices connected to the smart grid 10 as a whole may have a sufficient available capacity relative to the amount of power that can be generated within the region of the microgrid. This increases the degree of flexibility in electricity storage and power transfer in the smart grid 10 and thereby improves user convenience. The smart grid 10 managed by the information processing apparatus 100 disclosed herein allows, for example, an electricity storage operator A5 as illustrated in FIG. 2 that has an electricity storage device provided with a large-scale electricity storage capability and operates an electricity storage service through the smart grid 10 as their main service to be viable.

### Information Processing Apparatus 100

The information processing apparatus 100 for the smart grid 10 is an apparatus that processes information of the smart grid 10. The information processing apparatus 100 may be implemented by, for example, a computer that executes predetermined processes according to an embedded program. In the embodiment shown in FIG. 2, the information processing apparatus 100 is incorporated in a cloud server of the resource aggregator 13 connected to the communication network 40 of the smart grid 10 as one of its functions. Each of various processes executed by the information processing apparatus 100 may be implemented as a processing module that executes predetermined operational processes according to a predetermined program.

In addition to being used for self-consumption, the electric power generated by the power generation devices 51 to 55 connected to the smart grid 10 is stored in their own storage batteries and their own electric vehicles. When surplus electric power arises, the surplus electric power is supplied to the smart grid 10. The information processing apparatus 100 may be configured to execute an electricity selling process each time when this occurs. When a shortfall of electric power occurs, the electric power surplus electric power is supplied to the smart grid 10. The information processing apparatus 100 may be configured to execute an electricity purchasing process each time when this occurs.

For example, the user of the residential house A1 may store the electric power generated by the user’s own power generation device 51 into an electricity storage device 61. It is also possible to supply the electric power generated by the user’s own power generation device 51 to the smart grid 10. Each time when electric power is supplied to the smart grid 10, the electric power is sold to an electric power utility operator. The electric power supplied to the smart grid 10 is consumed through the smart grid 10 by a consumer connected to the smart grid 10. Each time when the consumer receives electric power from the smart grid 10, the consumer purchases electricity from the electric power utility operator.

On the other hand, the smart grid 10 is connected to the plurality of electricity storage devices 61 to 65. The plurality of electricity storage devices 61 to 65 may be configured so that the charging and discharging can be controlled, for example, according to an instruction from the resource aggregator 13. The present inventors believe that, in this type of smart grid 10, the user of the residential house A1 is able to store surplus electric power that occurs at the user’s own house through the smart grid 10. For example, the surplus electric power of the user of the residential house A1 may be controlled so that the surplus electric power of the smart grid 10 can be stored through the smart grid 10 into the plurality of electricity storage devices 61 to 65 connected to the smart grid 10. In this case, when the electric power generated by the user’s own power generation device 51 of the user of the residential house A1 is supplied to the smart grid 10, it is also possible to store the electric power into the plurality of electricity storage devices 61 to 65 connected to the smart grid 10 through the control by the resource aggregator 13.

This allows the user of the residential house A1 to store the electric power into the plurality of electricity storage devices 61 to 65 connected to the smart grid 10 when the electric power generated by the user’s own power generation device 51 is supplied to the smart grid 10. Through the smart grid 10, the user can receive the electric power stored in the plurality of electricity storage devices 61 to 65 connected to the smart grid 10 at any time the user wishes. Such a control is made possible by the smart grid 10, which includes the transmission grid 20 and the communication network 40 and is controlled by information technology. In this case, the user is allowed to choose to store the surplus electric power into the smart grid 10 each time instead of being processed as a sale of electricity.

From such a viewpoint, the present inventors have conceived that the information processing apparatus 100 for the smart grid 10 is allowed to store a virtual electrical storage capacity that is defined as an amount of electric energy corresponding to the amount of electric energy in which a user is allowed to receive electric power from the smart grid 10, in association with the user. This allows the electric power discharged from the user to the smart grid 10 to be recorded as the electric power that is stored in the smart grid 10 or as the electric power that the user is allowed to receive from the smart grid 10. This means that the user is able to store surplus electric power through the smart grid 10. The stored electric power is recorded as a virtual electrical storage capacity corresponding to the amount of electric energy that the user is allowed to receive from the smart grid 10. Thus, by recording the virtual electrical storage capacity in association with the user in the information processing apparatus 100 for the smart grid 10, the information processing apparatus 100 is able to control the smart grid 10 so that the user can receive the corresponding amount of electric power according to the virtual electrical storage capacity stored in association with the user. This enables the user to store the electric power generated at the user’s own house through the smart grid 10 and to use the stored electric power at any time, so that the user does not need to sell electricity each time.

### Processes M1 to M12 Executed by Information Processing Apparatus 100

In this embodiment, the processes executed by the information processing apparatus 100 include a first recording process m1, a depositing process m2, a withdrawal process m3, a transferring process m4, a purchasing process m5, a selling process m6, a price setting process m7, an exchange process m8, an exchange setting process m9, a capacity-data transmission process m10, a second recording process m11, and a sharing setting process m12. Each of the processes m1 to m12 is implemented by a process according to a program embedded in the information processing apparatus 100. It is to be understood that this description merely illustrates examples of the processes executed by the information processing apparatus 100, and that the processes executed by the information processing apparatus 100 are not limited to the examples illustrated herein.

### First Recording Process M1

The first recording process m1 is a process of recording virtual electrical storage capacities in association with respective users, each virtual electrical storage capacity corresponding to the amount of electric energy in which a corresponding user is allowed to receive from the smart grid 10. The virtual electrical storage capacity is a datum that can be handled by the information processing apparatus 100. The virtual electrical storage capacity is the amount of electric energy corresponding to the amount of electric energy in which a user is allowed to receive from the smart grid 10, which is recorded in the information processing apparatus 100 in association with the user. The virtual electrical storage capacity may also be considered as the right to receive the corresponding amount of electric energy from the smart grid 10. The virtual electrical storage capacity may also be considered as the amount of electric energy that the user has stored in the smart grid 10. The virtual electrical storage capacity may be considered as the amount of electric energy that the user has stored in the smart grid 10 and also considered as the right to receive the corresponding amount of electric energy through the smart grid 10. Note that it does not matter whether the amount of electric energy that is actually stored by the user through the smart grid 10 into the electricity storage devices 61 to 65 connected to the smart grid 10 matches the virtual electrical storage capacity that is recorded in the information processing apparatus 100 as information.

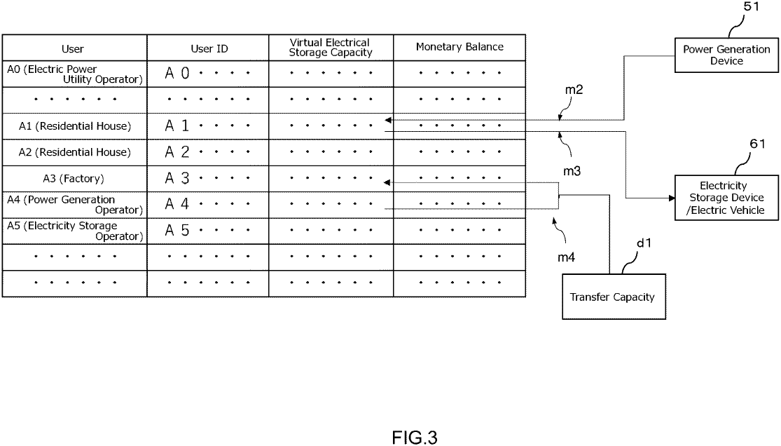

The information processing apparatus 100 may include a memory storage unit that stores virtual electrical storage capacities in association with users. Each of the users may be assigned an ID for identifying the user. Since the virtual electrical storage capacities are stored in association with the respective users in the information processing apparatus 100, the information processing apparatus 100 can handle each of the virtual electrical storage capacities as the amount of electric energy that a user can freely dispose of. In other words, in reality, the virtual electrical storage capacities may be data that can be handled by a computer. FIG. 3 is a configuration diagram illustrating an example of the configuration of a memory storage unit that stores virtual electrical storage capacities in association with users. As illustrated in FIG. 3, in the information processing apparatus 100, user IDs and virtual electrical storage capacities may be recorded in a table that can record the user IDs and the virtual electrical storage capacities side by side. The virtual electrical storage capacities may be denoted in a unit that is used for amount of electric energy so that they can be handled in the same way as is the amount of electric energy.

Also in this embodiment, as illustrated in FIG. 3, the information processing apparatus 100 is configured to be able to record monetary balances in association with user IDs. For the monetary balances, for example, it is possible to use a similar system to mobile payments, and the monetary balances may be linked to various payments, such as a bank account payment (immediate payment), a credit card payment (post payment), a charge payment (pre-payment), and a point payment, which are used for mobile payments. For example, in the case of bank account payment (immediate payment), the amount used is instantly debited from a predetermined bank account of the user according to the amount charged to the monetary balance. In the case of credit card payment (post payment), a credit card used by the user is preregistered, and a payment is made by the credit card according to the amount charged to the monetary balance. In the case of charge payment (pre-payment), cash can be used at a terminal or a checkout for charging, and it is also possible that a certain amount may be charged by a credit card or from a bank account. In the case of point payment, the points awarded according to the use and purchase of goods and services may be exchanged to a monetary balance so that the monetary balance can be used for payment for the price of the service that utilizes the virtual electrical storage capacity provided here. It is also possible to use the awarded points as they are for the payment for the price of the service that utilizes the virtual electrical storage capacity provided here.

Specifically, in the embodiment shown in FIG. 2, the residential house A1 can contribute to the adjustment of demand and supply of electricity in the smart grid 10 by means of power generation by the solar panels as the power generation device 51, electricity storage in the electric vehicle 71, and discharging of electric power from the electric vehicle 71 to the smart grid 10. The resident of the residential house A1 may become a user of the smart grid 10 based on a predetermined contract agreement. The electric power generated by the solar panels as the power generation device 51 is used as the electric power to be used in the residential house A1, and moreover, a surplus of the electric power is supplied to the smart grid 10. In this case, if the smart grid 10 has a surplus electric power, the surplus electric power may be charged into the electricity storage devices 61 to 65 connected to the smart grid 10 in the adjustment of demand response (DR). In this embodiment, the information processing apparatus 100 deals with the surplus electric power supplied from the residential house A1 as the one that is stored in the electricity storage devices 61 to 65 connected to the smart grid 10, not as the one that has been sold. In this case, the information processing apparatus 100 measures the amount of electric energy corresponding to the surplus electric power supplied from the residential house A1 to the smart grid 10 as a virtual electrical storage capacity. The virtual electrical storage capacity measured here is associated with the resident of the residential house A1 as the user. The amount of electric energy corresponding to the surplus electric power supplied from the residential house A1 to the smart grid 10 may be measured by a smart meter installed to the residential house A1.

### Power Generation Device ID

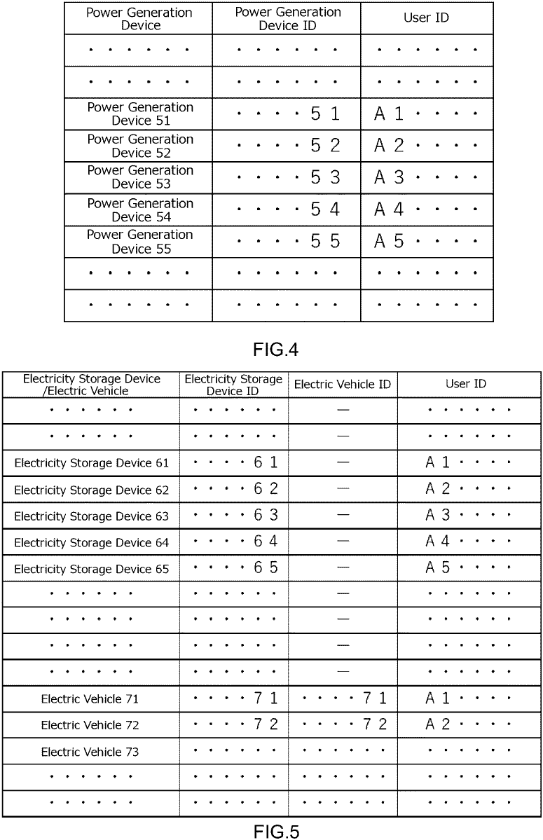

The information processing apparatus 100 may include a memory storage unit that stores information indicative of the power generation devices 51 to 55 connected to the smart grid 10 in association with the users. FIG. 4 is a table illustrating an example of the configuration of a memory storage unit that stores information indicative of power generation devices 51 to 55 in association with users. In this embodiment, the power generation devices 51 to 55 are assigned respective power generation device IDs as their identification numbers. As illustrated in FIG. 4, the power generation device IDs and the user IDs may be recorded in a table that can record the power generation device IDs and the user IDs side by side. For example, when the present system that uses virtual electrical storage capacities is used among the power generation devices 51 to 55 connected to the smart grid 10, power generation device IDs may be assigned to the power generation devices 51 to 55 that are connectable to the smart grid 10 according to the contract agreement between the users and the resource aggregator, and the power generation device IDs may be recorded in association with the user IDs.

### Electricity Storage Device ID and Electric Vehicle ID

The information processing apparatus 100 may include a memory storage unit that stores information indicative of the electricity storage devices 61 to 65 connectable to the smart grid 10 in association with the users. FIG. 5 is a table illustrating an example of the configuration of a memory storage unit that stores data representing electricity storage devices 61 to 65 in association with users. In this embodiment, the electricity storage devices 61 to 65 are assigned respective electricity storage device IDs as their identification numbers. As illustrated in FIG. 5, the electricity storage device IDs and the user IDs may be recorded in a table that can record the electricity storage device IDs and the user IDs side by side. For example, when a user utilizes the present system that uses virtual electrical storage capacities, electricity storage device IDs may be assigned to the electricity storage devices 61 to 65 that are connectable to the smart grid 10 according to a contract agreement or the like between the user and the resource aggregator, and the electricity storage device IDs may be record in association with the user ID. The electric vehicles 71 to 73 may be connected to the smart grid 10 to serve as electricity storage devices when appropriate. In this embodiment, as illustrated in FIG. 5, the electric vehicles 71 to 73 are assigned respective electricity storage device IDs and are recorded in association with user IDs. The electric vehicles 71 to 73 may desirably be distinguished from the stationary-type electricity storage devices 61 to 65. As illustrated in FIG. 5, the electric vehicles may be assigned respective electric vehicle IDs, separately from the electricity storage device IDs. Note that the electric vehicle IDs may be associated with the users and recorded in a table that is different from the one that stores the electricity storage device IDs.

### Depositing Process M2

The depositing process m2 is a process of increasing the virtual electrical storage capacity of a user according to the amount of electric energy that is output to the transmission grid 20 from an electrical equipment unit associated with the user. The electrical equipment units associated with the users may include, for example, the power generation devices 51 to 55, the electricity storage devices 61 to 65, the electric vehicles 71 to 73, and the like. It is possible to use a smart meter, for example, to measure the amount of electric energy that is output to the transmission grid 20 from the power generation devices 51 to 55, the electricity storage devices 61 to 65, and the electric vehicles 71 to 73, which serve as the electrical equipment units.

For example, in the depositing process m2, when electric power is output from one of the power generation devices 51 to 55 to the transmission grid 20, the power generation device from which electric power is output and the user thereof are identified. Then, the virtual electrical storage capacity of the corresponding user recorded in the first recording process m1 is increased according to the amount of electric energy that is output to the transmission grid 20 from the one of the power generation devices 51 to 55 (see FIG. 3). The electrical equipment units that are allowed to output electric power to the transmission grid 20 are not limited to the power generation devices 51 to 55. For example, the electricity storage devices 61 to 65 and the electric vehicles 71 to 73 may also output electric power to the smart grid 10. In that case as well, in the depositing process m2, the one of the electrical equipment units from which electric power is output and the corresponding user are identified. Then, the virtual electrical storage capacity of the corresponding user recorded in the first recording process m1 is increased according to the amount of electric energy that is output from the one of the electrical equipment units to the transmission grid 20 (see FIG. 3).

For example, as illustrated in FIG. 2, the depositing process m2 increases the virtual electrical storage capacity of the resident (i.e., the user) of the residential house A1 when surplus electric power arises in the residential house A1 and electric power is discharged from the residential house A1 to the transmission grid 20 of the smart grid 10. The depositing process m2 may predetermine how much virtual electrical storage capacity should be increased according to the amount of electric energy that is output to the transmission grid 20. For example, the depositing process m2 may be configured to increase the virtual electrical storage capacity by the same amount as the amount of electric energy output from the power generation device 51 to the smart grid 10.

In this case, in the depositing process m2, the virtual electrical storage capacity is updated according to the following equation (f1).

Virtual Electrical Storage Capacity = Virtual Electrical Storage Capacity (0) + Discharged Electric Energy ... (f1)

Here, virtual electrical storage capacity (0) is the virtual electrical storage capacity before the depositing process m2, and discharged electric energy is the amount of electric energy that is discharged from the residential house A1 to the transmission grid 20 of the smart grid 10. For example, the depositing process m2 may be configured to increase the virtual electrical storage capacity of the user of the residential house A1 by 1 kWh when 1 kWh of electric power is discharged from the residential house A1 to the smart grid 10.

How much virtual electrical storage capacity should be increased according to the amount of electric energy in the depositing process m2 may be determined by simply adding the discharged electric energy, as in the foregoing equation (f1). The amount of the virtual electrical storage capacity to be increased in the depositing process m2 is not limited to being determined by the equation (f1) but may be set to a predetermined amount. For example, the depositing process m2 may be configured to increase the virtual electrical storage capacity by increasing or decreasing a predetermined proportion of the amount of electric energy that is output to the transmission grid 20 from one of the power generation devices 51 to 55 associated with a user. In other words, there may be a difference between the amount of electric energy that is output to the smart grid 10 and the amount of the virtual electrical storage capacity to be increased. For example, taking power transmission loss into account, the virtual electrical storage capacity to be increased may be reduced relative to the amount of electric energy that is output from a user to the smart grid 10.

For example, in the case where electric power supply and demand are tight, the tightness of electric power supply in the smart grid 10 is alleviated when electric power stored in an electricity storage device 61 or the like in the residential house A1 is discharged to the smart grid 10. Accordingly, the depositing process m2 may be configured to increase the virtual electrical storage capacity by adding a predetermined amount to the amount of electric energy that is output from the electricity storage device 61 to the smart grid 10. In this case, for example, in the case of adding 5% of the amount of electric energy that is output from the electricity storage device 61 to the smart grid 10, the depositing process m2 may be configured to increase the virtual electrical storage capacity by 1.05 kWh when 1 kWh of electric power is output from the electricity storage device 61 to the smart grid 10. This serves to alleviate the tightness of electric power supply in the smart grid 10 and also provides the user with an advantage of storing the virtual electrical storage capacity more efficiently. In addition, in the case where the smart grid 10 has a surplus of electric power, for example, the tightness of electric power supply is alleviated when the electric power stored in an electricity storage device or the like in the residential house A1 is discharged to the smart grid 10. In this way, adjusting the amount of the virtual electrical storage capacity to be increased in the depositing process m2 may be used to adjust the supply and demand of electric power.

In addition, the depositing process m2 may be configured to deduct a predetermined amount corresponding to a commission fee from the virtual electrical storage capacity. The amount corresponding to the commission fee may be set freely, and may be predetermined in the information processing apparatus 100. For example, a predetermined proportion of the amount of electric energy that is output from an electrical equipment unit of the user to the smart grid 10 may be deducted, as the amount corresponding to the commission fee, from the virtual electrical storage capacity to be added. As a specific example, in the case of deducting 5% of the amount of electric energy that is output from the power generation device 51 to the smart grid 10, the depositing process m2 may be configured to increase the virtual electrical storage capacity by 0.95 kWh when 1 kWh of electric power is output from the power generation device 51 to the smart grid 10. Thus, by deducting the amount corresponding to the commission fee for the service of using the virtual electrical storage capacity from the virtual electrical storage capacity, the commission fee for the service of using the virtual electrical storage capacity can be cleared off by the virtual electrical storage capacity. This makes it possible to eliminate or reduce the process of clearing off the commission fee for the service of using the virtual electrical storage capacity with the use of money or points.

### Withdrawal Process M3

The withdrawal process m3 is a process of reducing the virtual electrical storage capacity of a user according to the amount of electric energy received by the user from the transmission grid 20.

In the withdrawal process m3, when a user receives electric power from the transmission grid 20, the user is identified from the device with which the user receives electric power. For example, when electric power is received and consumed from the transmission grid 20 at the residential house A1, the user is identified from a smart meter installed on the residential house A1. Likewise, when an electric vehicle is charged at a charging spot A6 in a city, the user is identified by acquiring an electric vehicle ID from the electric vehicle. Then, the virtual electrical storage capacity of the user recorded in the first recording process m1 is reduced according to the amount of electric energy that received by the user from the transmission grid 20 (see FIG. 3).

For example, as illustrated in FIG. 2, the withdrawal process m3 reduces the virtual electrical storage capacity of the resident (i.e., the user) of the residential house A1 in place of the electricity purchase process when a shortage of electric power occurs in the residential house A1 and the residential house A1 receives and uses electric power from the transmission grid 20 of the smart grid 10. Likewise, when a user receives electric power from the smart grid 10 through a charging station at a charging spot A6 in a city as well, the withdrawal process m3 may be used to reduce the virtual electrical storage capacity of the corresponding user. Thus, when a user receives electric power from the smart grid 10, the virtual electrical storage capacity of the corresponding user is reduced according to the amount of electric energy received. When a user receives electric power from the smart grid 10, the withdrawal process m3 may deduct an equivalent amount of electric energy from the virtual electrical storage capacity of corresponding user. This enables the user to receive electric power from the smart grid 10 using the virtual electrical storage capacity, without using the electricity purchase process.

The withdrawal process m3 may predetermine how much virtual electrical storage capacity should be reduced according to the amount of electric energy that is received by a user. For example, the withdrawal process m3 may be configured to reduce the virtual electrical storage capacity by the same amount as the amount of electric energy received by the user from the smart grid 10.

In this case, the withdrawal process m3 updates the virtual electrical storage capacity, for example, according to the following equation (f2).

$$\begin{matrix}\text{Virtual Electrical Storage Capacity =} \\ \text{Virtual Electrical Storage Capacity} \left(0\right) - \text{Receieved Electric Energy}\end{matrix} \qquad \text{(f2)}$$

Here, virtual electrical storage capacity (0) is the virtual electrical storage capacity before the withdrawal process m3, and received electric energy is the amount of electric energy received by the user from the smart grid 10. For example, when a user receives 1 kWh of electric power from the smart grid 10 through a charging station at a charging spot A6 in a city, the withdrawal process m3 may be configured to reduce the virtual electrical storage capacity of the corresponding user by 1 kWh. Thus, an equivalent amount of virtual electrical storage capacity is reduced by the withdrawal process m3 for the virtual electrical storage capacity when electric power is received from the smart grid 10, but the cash asset of the user is not directly reduced.

How much virtual electrical storage capacity should be reduced according to the amount of electric energy in the withdrawal process m3 may be determined by simply subtracting the received electric energy, as specified by the foregoing equation (f2). The amount of the virtual electrical storage capacity to be reduced in the withdrawal process m3 is not limited to being determined by the equation (f2) but may be set to a predetermined amount. For example, the withdrawal process m3 may be configured to reduce the virtual electrical storage capacity by increasing or decreasing a predetermined proportion of the amount of electric energy that is output to the transmission grid 20 from one of the power generation devices 51 to 55 associated with a user. In other words, there may be a difference between the amount of electric energy that is supplied from the smart grid 10 and the amount of the virtual electrical storage capacity to be reduced. For example, taking power transmission loss into account, the virtual electrical storage capacity to be reduced may be increased relative to the amount of electric energy supplied from the smart grid 10 to the user.

In the case where electric power supply and demand are tight, the tightness of electric power supply in the smart grid 10 is alleviated by reducing the amount of discharging from the smart grid 10. In this case, it is desired to reduce the amount of discharging from the smart grid 10. For this reason, in the case where the electric power supply and demand are tight, the withdrawal process m3 may be configured to reduce the virtual electrical storage capacity by adding an extra amount of electric power corresponding to the tightness of electric power supply and demand to the amount of electric energy received from the smart grid 10. In this case, for example, in the case of adding 5% of the amount of electric energy that has been received from the smart grid 10, the withdrawal process m3 may be configured to reduce the virtual electrical storage capacity by 1.05 kWh when 1 kWh of electric power is received from the smart grid 10. This allows the user to be prompted to reduce electric power consumption and enables the smart grid 10 to alleviate the tightness in electric power supply. In addition, in such a case where the smart grid 10 has a surplus of electric power and the electricity storage devices 61 to 65 connected to the smart grid 10 have a low available capacity, it is possible to reduce the amount of electric energy for reducing the virtual electrical storage capacity relative to the amount of electric energy received from the smart grid 10. This allows the user to be prompted to increase electric power consumption. In this way, adjusting the amount of the virtual electrical storage capacity to be reduced in the withdrawal process m3 may be used to adjust the supply and demand of electric power.

In addition, the withdrawal process m3 may be configured to deduct a predetermined amount corresponding to a commission fee from the virtual electrical storage capacity. It is possible to set the amount corresponding to the commission fee freely. For example, a predetermined proportion of the amount of electric energy that has been received by a user from the smart grid 10 may be added, as the amount corresponding to the commission fee, to the amount of the virtual electrical storage capacity to be reduced. As a specific example, in the case where the amount corresponding to the commission fee is set to 5% of the amount of electric energy that the user has received from the smart grid 10, the withdrawal process m3 may be configured to reduce the virtual electrical storage capacity by 1.05 kWh when the user receives 1 kWh of electric power from the smart grid 10. In this case as well, by deducting the amount corresponding to the commission fee for the service of using the virtual electrical storage capacity from the virtual electrical storage capacity, the commission fee for the service of using the virtual electrical storage capacity can be cleared off by the virtual electrical storage capacity. This makes it possible to eliminate or reduce the process of clearing off the commission fee for the service of using the virtual electrical storage capacity with the use of money or points.

The system of using the virtual electrical storage capacity provided by this information processing apparatus 100 may be operated by, for example, an electric power utility operator or a resource aggregator as the operator. The commission fee for using the system and service of using the virtual electrical storage capacity may be billed monthly or yearly at a flat rate from the operator to the user who uses the system of using the virtual electrical storage capacity provided by this information processing apparatus 100. In this case, it is unnecessary to set the amount of commission fee every time the depositing process m2 or the withdrawal process m3 is performed. The system of using the virtual electrical storage capacity provided by this information processing apparatus 100 may be offered to users without charging fees. The system of using the virtual electrical storage capacity serves to reduce the processes and administrative burden that involves monetary exchange resulting from the sales and purchases of electricity by the users. Accordingly, it is expected that the system of using the virtual electrical storage capacity will become widely available if the system is offered to users without charging fees corresponding to such an administrative burden, for example, for free.

As described above, the information processing apparatus 100 disclosed herein executes a first recording process m1 of recording a virtual electrical storage capacity in association with a user, a depositing process m2, and a withdrawal process m3. The first recording process m1 involves recording a virtual electrical storage capacity in association with a user. The depositing process m2 involves increasing the virtual electrical storage capacity of the corresponding user according to the amount of electric energy that is output to the transmission grid 20 from an electrical equipment unit associated with the user. The withdrawal process m3 involves reducing the virtual electrical storage capacity of the corresponding user according to the amount of electric energy that has been used by the user from the transmission grid 20. This allows the user to store generated electric power in the smart grid 10 in the form of virtual electrical storage capacity and to receive electric power through the smart grid 10 using the virtual electrical storage capacity.

The virtual electrical storage capacity recorded in the first recording process m1 may also be treated as the amount of electric energy that is actually stored in the electricity storage devices 61 to 65 connected to the smart grid 10. The user is allowed to receive electric power through the smart grid 10 according to the amount of electric energy of the virtual electrical storage capacity. In addition, the virtual electrical storage capacity is the amount of electric energy that is considered as the electric power that can be virtually disposed of freely by the user. Also, the virtual electrical storage capacity may be the electric power that can be virtually disposed of freely by the user.

In the depositing process m2, the user is, for example, allowed to virtually store the electric power generated in the residential house A1 as the virtual electrical storage capacity in the smart grid 10, without selling the electric power as surplus electric power. In the withdrawal process m3, the user is allowed to use the electric power stored as the virtual electrical storage capacity through the smart grid 10 at any desired location and at any desired time. Therefore, the user does not need to purchase electricity each time when the user receives electric power from the smart grid 10, as long as a sufficient virtual electrical storage capacity has been stored.

As a result, for example, as long as sufficient electricity storage devices are connected to the smart grid 10 so as to be able to accept surplus electric power from the residential house A1, surplus electric power can be stored in the smart grid 10 as a virtual electrical storage capacity even when the residential house A1 is not provided with a stationary-type electricity storage device. This means that, by storing surplus electric power as the virtual electrical storage capacity in the smart grid 10, it is possible to obtain a condition similar to that in which there is a stationary-type electricity storage device in the residential house A1 even when the residential house A1 is not provided with a stationary-type electricity storage device. As a result, the user of the residential house A1 can reduce the capacity of the stationary-type electricity storage device or altogether eliminate the installation of the stationary-type electricity storage device, for example, to reduce the cost to be spent on the stationary-type electricity storage device.

Moreover, when the user possesses an electric vehicle that is connectable to the smart grid 10, the user is able to use the virtual electrical storage capacity to feed electric power to the electric vehicle at any desired location through the smart grid 10. In this case, as illustrated in FIG. 5, the electric vehicle ID of the electric vehicle is stored in association with the user ID as well as with the electricity storage device. For this reason, the withdrawal process m3 of the information processing apparatus 100 may be programmed to recognize the electric vehicle ID when the electric vehicle is connected even if the electric vehicle is charged using a charging station that can be connected to the smart grid 10 at any location. Thereby, when the electric vehicle ID is identified, the corresponding user ID is identified, and the amount of electric energy equivalent to the amount of electric energy received by the electric vehicle is subtracted from the virtual electrical storage capacity of the user that has been identified by the corresponding user ID.

Thus, by using the virtual electrical storage capacity achieved by the information processing apparatus 100 proposed herein, the user is able to virtually store the electric power generated at his/her own house in the smart grid 10. The user is allowed to receive the electric power that is virtually stored in the smart grid 10 in the form of virtual electrical storage capacity through the smart grid 10 when a shortage of electric power occurs in the residential house A1. The user is also allowed to receive electric power from the smart grid 10 to an electric vehicle using the virtual electrical storage capacity even at a travel destination.

Thus, the virtual electrical storage capacity may also be considered as the right to receive a corresponding amount of electric energy from the smart grid 10. In other words, the virtual electrical storage capacity may be considered as the amount of electric energy that the user has stored in the smart grid 10 and also considered as the right to receive the corresponding amount of electric energy through the smart grid 10. For example, when the user is a resident of the residential house A1 equipped with solar panels and goes out for a trip to a distant location on a weekend using the electric vehicle 71, the electric power generated by the solar panels is stored as a virtual electrical storage capacity through the smart grid 10. Since the virtual electrical storage capacity is the right to receive a corresponding amount of electric power through the smart grid 10, the user is allowed to receive electric power from the smart grid 10 using the stored virtual electrical storage capacity when the user connects the electric vehicle to the smart grid 10 at a charging spot at the travel destination. At that time, a process is performed to reduce the virtual electrical storage capacity of the user according to the amount of electric energy that has been received by the user. In such a way, the user is able to virtually store the electric power generated at the user’s own house into the smart grid 10 and to receive electric power at any desired time and at any desired location. As a result, by storing the electric power generated at the residential house A1 into the smart grid 10 as a virtual electrical storage capacity, the user of the residential house A1 is allowed to maximally use the electric power generated at the user’s own house without leaving a surplus of electric power.

The user is not limited to the level of individual person. For example, a solar panel power generation operator may be able to store a virtual electrical storage capacity by using the virtual electrical storage capacity when discharging electric power to the smart grid 10. When the solar panel power generation operator needs to use electric power for another business operation, the power generation operator is able to receive electric power from the smart grid 10 using the virtual electrical storage capacity that has been stored by the solar panel power generation. Thus, the user may be at the level of juristic person. Accordingly, large-scale consumers that also conduct a power generation business or the like may also be employed as users, and the virtual electrical storage capacity is managed in a centralized manner so that the amount of electric power used can be cleared off by the virtual electrical storage capacity. A juristic person user may store the electric power generated by a power generation business into the smart grid 10 and consume the electric power for another business operation. Thus, the user is not limited to the level of individual person. When, as described above, electric power is received from the smart grid 10 through the withdrawal process m3 using the virtual electrical storage capacity, not through sales of electricity or purchases of electricity, for example, the information processing apparatus 100 may be configured to communicate with a control terminal of the user and execute a predetermined process in cooperation with the control terminal of the user. When this is the case, the electric power utility operator also uses electric power through the virtual electrical storage capacity, which reduces the processes of paying money to users according to the sales of electricity by the users and receiving money according to the purchases of electricity by the users. This reduces administrative burden that accompanies monetary exchange in comparison with the cases where interchange of electric power is processed each time by sales of electricity and purchases of electricity.

The information processing apparatus 100 may be configured to be able to perform various processes, such as transferring, purchasing, and selling processes of the virtual electrical storage capacity. In these processes, the information processing apparatus 100 may be configured to communicate with a control terminal of the user and execute a predetermined process in cooperation with the control terminal of the user. The control terminal of the user may be a personal computer, a smartphone, or the like, for example. The control terminal of the user may be a control terminal for HEMS or the like installed for monitoring the interchange of electric power with a smart meter. The information processing apparatus 100 may be configured to be provided with a dedicated web site so that predetermined information can be input through the web site. Alternatively, the information processing apparatus 100 may be configured to include dedicated software embedded in a personal computer or a smartphone so that predetermined information can be input through the processes of the software. For example, the information processing apparatus 100 may be configured to communicate with a personal computer or a smartphone and cause a control terminal of the user to display a control screen panel for executing various processes so that necessary information can be input therein. The information processing apparatus 100 may be configured to be able to obtain information necessary for the processes of transferring, purchasing, and selling of the virtual electrical storage capacity through these control terminals of users.

### Transferring Process M4

The transferring process m4 is a process of transferring the virtual electrical storage capacity between users. For example, as illustrated in FIG. 3, when the virtual electrical storage capacity is transferred from the power generation operator A4, which can store the virtual electrical storage capacity easily by power generation, to the factory A3, which consumes a large amount of electric power, the transferor user A4 and the transferee user A3 may be identified with their user IDs and the capacity to be transferred (transfer capacity d1) may be determined. The information of the transferor user A4, the transferee user A3, and the transfer capacity d1 may be obtained through, for example, the control terminal of the user.

In this case, the virtual electrical storage capacity of the transferor user A4 may be reduced by an amount corresponding to the transfer capacity, and the virtual electrical storage capacity of the transferee user A3 may be increased by the amount corresponding to the transfer capacity. As described above, the virtual electrical storage capacity can be transferred between users. This allows electric power to be interchanged between the users by the process of transferring the virtual electrical storage capacity, not by the sales or purchases of electricity. That is, the user who has received the transfer of the virtual electrical storage capacity can receive an amount of electric power corresponding to the transferred virtual electrical storage capacity through the smart grid 10. The transferring process m4 enables transferring and leasing of the virtual electrical storage capacity without transferring money between the users. Although the virtual electrical storage capacity is transferred in this case, the actual electric power is interchanged through the smart grid 10. For this reason, it is unnecessary to actually transfer the electric power corresponding to the transferred amount between the electricity storage devices of the users.

### Purchasing Process M5

The purchasing process m5 is a process of purchasing the virtual electrical storage capacity of a user. The purchasing process m5 includes an embodiment in which the user purchases the virtual electrical storage capacity from an electric power utility operator, for example, and an embodiment in which the user purchases the virtual electrical storage capacity from another user. Note that, if the electric power utility operator is considered as one of the users, both embodiments may be implemented by the same process.

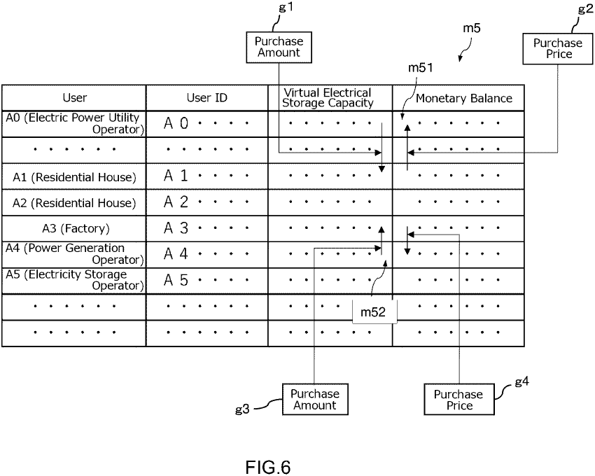

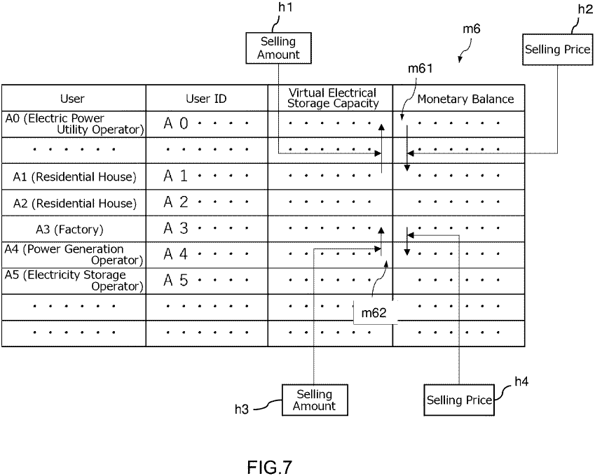

FIG. 6 is a schematic view illustrating processes m51 and m52, each of which is an example of purchasing process m5. In the example shown in FIG. 6, the user A1 purchases the virtual electrical storage capacity from an electric power utility operator A0 in the purchasing process m51. As described previously, the virtual electrical storage capacity may also be considered as the right to receive electric power from the smart grid 10. In this case, the information processing apparatus 100 determines the seller to be the electric power utility operator A0, and identifies a purchaser user A1, a purchase amount g1, and a purchase price g2. In the purchasing process m5, the virtual electrical storage capacity of the user may be increased according to the purchase amount. On the other hand, the monetary balance of the user may be reduced according to the purchase amount. Alternatively, the monetary balance of the electric power utility operator may be increased according to the purchase amount.

Here, the monetary balances managed by the information processing apparatus 100 may be managed as the record of monetary values each time. For example, the operator that offers the system or service of using the virtual electrical storage capacity does not need to produce monetary exchange between the users each time. The purchasing process m5 may also be configured to exchange the monetary balance as appropriate for commercially usable points that are given to the user. The purchasing process m5 may also be configured to allow the user to check the monetary balance as necessary and allow the user to request a money transfer into a bank account actually owned by the user or request an exchange process for points. The purchasing process m5 may be configured to allow the operator that offers the system and service of using the virtual electrical storage capacity to execute a money transfer process or an exchange for points through a payment handling operator such as a bank or a credit card company. When the purchasing process m5 is configured to allow the operator to execute a money transfer process or an exchange for points through a payment handling operator, the operator does not need to directly hold or manage the information of bank accounts and credit cards of the users.

In the purchasing process m52, the user A3 purchases the virtual electrical storage capacity from the user A4. In this case, the information processing apparatus 100 determines the seller to be the user A4 and identifies a purchaser user A3, a purchase amount g3, and a purchase price g4. The information necessary for the purchasing process may be obtained through, for example, the control terminal of the user A3. In the purchasing process m52, the virtual electrical storage capacity of the user A3 may be increased and the virtual electrical storage capacity of the user A4 may be reduced according to the purchase amount g3. On the other hand, the monetary balance of the user A3 may be reduced and the monetary balance of the user A4 may be increased according to the purchase price g4. In this way, the purchasing process m5 may transfer the virtual electrical storage capacity between the vendor and the purchaser according to the purchase amount and also transfer the monetary balance between the vendor and the purchaser according to the purchase price. The information necessary for such a purchasing process m5 may be processed according to the input from, for example, the control terminal of the user that is a purchaser. For example, the information necessary for the selling process m51 may be obtained through the control terminal of the user A1 that is a purchaser. For example, the information necessary for the selling process m52 may be obtained through the control terminal of the user A3 that is a purchaser.

### Selling Process M6

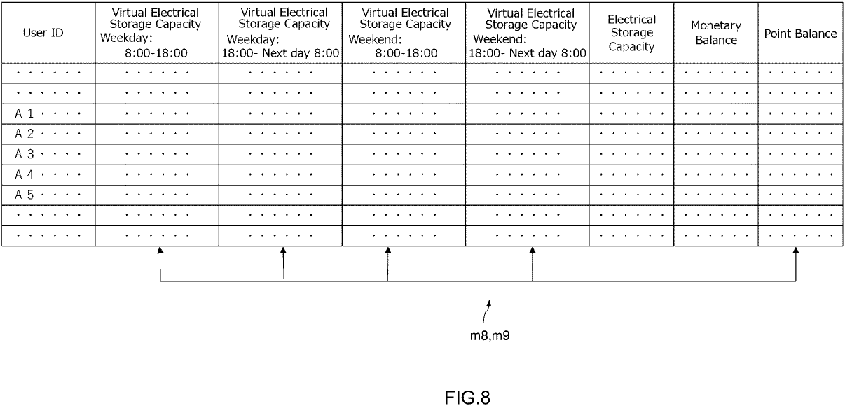

The selling process m6 is a process of selling the virtual electrical storage capacity of a user. FIG. 7 is a schematic view illustrating processes m61 and m62, each of which is an example of selling process m6. The selling process m6 includes an embodiment (m61) in which, for example, the user purchases the virtual electrical storage capacity from an electric power utility operator and an embodiment (m62) in which the user sells the virtual electrical storage capacity to another user. Note that, if the electric power utility operator is considered as one of the users, both embodiments may be implemented by the same process.

For example, as illustrated in FIG. 7, in the selling process m61 in which the user A1 sells the virtual electrical storage capacity to the electric power utility operator A0, the information processing apparatus 100 determines the seller to be the user A1 and the vendee to be the electric power utility operator A0, and identifies the selling amount h1 and the selling price h2. Then, the information processing apparatus 100 reduces the virtual electrical storage capacity of the user A1 and increases the virtual electrical storage capacity of the electric power utility operator A0 according to the selling amount h1. The information processing apparatus 100 may also increase the monetary balance of the user A1 and reduces the monetary balance of the electric power utility operator A0 according to the selling price h2. On the other hand, in the selling process m62 in which the user A4 sells the virtual electrical storage capacity to the user A3, the information processing apparatus 100 determines the seller to be the user A4 and the vendee to be the user A3, and identifies the selling amount h3 and the selling price h4. Then, the information processing apparatus 100 reduces the virtual electrical storage capacity of the user A4 and increases the virtual electrical storage capacity of the user A3 according to the selling amount h3. The information processing apparatus 100 may also increase the monetary balance of the user A4 and reduces the monetary balance of the user A3 according to the selling price h2. In this way, the selling process m6 enables the virtual electrical storage capacity to be sold between arbitrary users. The information necessary for such a selling process m6 may be processed according to the input obtained from, for example, the control terminal of the user that is a seller. For example, the information necessary for the selling process m61 may be obtained through the control terminal of the user A1 that is a seller. For example, the information necessary for the selling process m62 may be obtained through the control terminal of the user A4 that is a seller.

### Price Setting Process M7

The price setting process m7 is a process of setting a price per unit amount of the virtual electrical storage capacity. The price setting process m7 sets, for example, a distribution price applied when the virtual electrical storage capacity is traded between users.

For example, the service provider of the smart grid 10 may also serve as an electricity storage operator A5 equipped with a large-scale electricity storage equipment 65 that has sufficient capability of storing electric power discharged to the smart grid 10. In addition, according to contract agreements with users, the service provider of the smart grid 10 may be configured to make use of the available capacity of the electricity storage devices 61 to 65 of the users. In this case as well, the service provider of the smart grid 10 may also have sufficient capability of storing electric power discharged to the smart grid 10. In this case, the service provider of the smart grid 10 may adjust the amount of electric energy supplied to smart grid 10 by the electricity storage device 65 appropriately. The service provider of the smart grid 10 can set the price per unit amount of the virtual electrical storage capacity that serves as the reference appropriately in the information processing apparatus 100. The price set here may serve as the reference price per unit amount of the virtual electrical storage capacity because it may be widely made available to users. The resource aggregator 13 can control the smart grid 10 to adjust the electric power supply and demand. Accordingly, the resource aggregator 13 may serve the role of such a service provider of the smart grid 10.

Moreover, by means of the price setting process m7, for example, the electric power utility operator A0 can set the price per unit amount of the virtual electrical storage capacity that is applied when trading the virtual electrical storage capacity between users. The power generation operator A4 with solar panels can set the price per unit amount for selling of the virtual electrical storage capacity. The factory operator A3 can set the price per unit amount for purchasing of the virtual electrical storage capacity. These prices may be made public on a web site that is open to users that are allowed to trade (sell and buy) the virtual electrical storage capacity, or on a closed web site between specific users. This is expected to promote trading of the virtual electrical storage capacity between users.

In this case, a restrictive condition under which a user is allowed to receive electric power from the smart grid may be specified for the virtual electrical storage capacity. When it is possible to specify restrictive conditions under which a user is allowed to receive electric power from the smart grid, the solar panel power generation operator A4 is able to sell a virtual electrical storage capacity provided with a restrictive condition under which electric power can be received from the smart grid. For example, the solar panel power generation operator A4 generates a large amount of power on a sunny day. However, if there is no business operator that uses the electric power, the power generation operator A4 may in some cases be forced to stop the power generation due to demand response. In such a circumstance, the solar panel power generation operator A4 may sell, at a low price, a virtual electrical storage capacity with a restrictive condition under which electric power is allowed to be received from the smart grid according to a peak time slot of the electric power generated by the solar panel power generation operator A4.

The electricity storage operator A5 may purchase such a low-price virtual electrical storage capacity to prompt the solar panel power generation operator to generate power, and may store the electric power into the electricity storage device 65 through the smart grid 10. The factory operator A3 is allowed to procure electric power at low cost, for example, when the factory is desired to increase the production. It is also possible to set the price of the virtual electrical storage capacity to be purchased concurrently with the time when the factory is desired to increase the production, to invite a power generation operator selling the virtual electrical storage capacity that is usable at that time, and to purchase the virtual electrical storage capacity that is usable at that time in advance. This means that, even in such cases where electric power supply becomes tight at a time when the factory needs to increase the production but the amount of electric energy to be used should be reduced due to a request from demand response, it is possible to obtain a virtual electrical storage capacity that can be used at that time and to thereby control the smart grid 10 to receive sufficient electric power preferentially.

From such a viewpoint, the virtual electrical storage capacity may be provided with a restrictive condition under which a user is allowed to receive electric power from the smart grid. FIG. 8 is a schematic view illustrating another embodiment of a table that is recorded in a first recording process m1. In this case, as illustrated in FIG. 8, for example, the first recording process m1 may record a virtual electrical storage capacity for each of restrictive conditions under which a user is allowed to receive electric power from the smart grid. As described previously, the virtual electrical storage capacity may be considered as the right to receive a corresponding amount of electric energy from the smart grid 10. In the first recording process m1, as illustrated in FIG. 8, the virtual electrical storage capacities may be set as the rights to be allowed to receive electric power from the smart grid 10 within a limited time, such as specified by time slots, time and date, and days of the week.

Thus, the price setting process m7 may be configured to, for example, store prices per unit amount of the virtual electrical storage capacity within a predetermined memory storage area of the information processing apparatus 100. The price setting process m7 may also be provided with the function of making the prices public between users that are able to trade (buy and sell) the virtual electrical storage capacity. Where the prices are made public may be a web site that is widely open to users or a closed web site that is made public between specific users.

In this case, for example, the price of the virtual electrical storage capacity may vary in association with the tightness of electric power supply and demand of the smart grid 10 that is managed by the resource aggregator 13. The price setting may be carried out in response to an electric power supply instruction from the aggregation coordinator 11. In the case of trading between users, the price per unit amount of the virtual electrical storage capacity may be set differently from, for example, the prices for sales of electricity or the purchases of electricity. Although the virtual electrical storage capacity is the right to receive electric power from the smart grid 10, it is possible to place a restriction on when to enforce the right. For example, the price of the virtual electrical storage capacity may be set for each of the restrictive conditions so that the price of the virtual electrical storage capacity varies depending on different time periods, such as time slots, times and dates, and days of the week, in which the user is allowed to receive electric power from the smart grid 10.

### Exchange Process M8 and Exchange Setting Process M9

The exchange process m8 is a process of exchanging the virtual electrical storage capacity for a predetermined commercially usable point. The exchange setting process m9 is a process of setting a number of points to be exchanged per unit of the virtual electrical storage capacity. Such an exchange process allows the virtual electrical storage capacity to be exchanged for commercially usable points. The exchange setting process m9 is a process of setting a number of points to be exchanged per unit of the virtual electrical storage capacity. In the exchanging for points as well, it is possible to set a reference exchange rate and to set an exchange rate for user-to-user trading, similar to the price setting for the virtual electrical storage capacity. In addition, the virtual electrical storage capacity to be exchanged may be provided with a restrictive condition under which a user is allowed to receive electric power from the smart grid 10. In the first recording process m1, point balances may be recorded in association with user IDs, as shown in FIG. 8. As a result of this, the point balances of users are recorded, the exchanges between virtual electrical storage capacities and points are also recorded.

The capacity-data transmission process m10 is a process of transmitting the virtual electrical storage capacity of a user to a predetermined terminal of the user. This allows the user to know the virtual electrical storage capacity. The information processing apparatus 100 may allow the user to check the virtual electrical storage capacity of the user, for example, through a web site to which the user can access with a terminal. The information processing apparatus 100 may periodically transmit information of the virtual electrical storage capacity to a pre-registered mail address of the user.

As described above, the virtual electrical storage capacity may be increased not only by outputting electric power to the transmission grid 20 of the smart grid 10 but also by transferring or purchasing of the virtual electrical storage capacity. For this reason, the depositing process m2 may not always be performed. Basically, the virtual electrical storage capacity reduces when electric power is received from the transmission grid 20 of the smart grid 10. However, power generation operators, individuals installed with a large number of solar panels, and the like output electric power to the transmission grid 20 of the smart grid 10 in many cases, so they tend to obtain virtual electrical storage capacity through the depositing process m2 more easily. These kinds of users may dispose of the virtual electrical storage capacity by selling the virtual electrical storage capacity or exchanging it for points. Thus, because the virtual electrical storage capacity corresponding to the amount of electric energy in which a user is allowed to receive from the smart grid is set in association with the user, it is possible to achieve electricity trading with a higher degree of freedom and to improve user convenience in utilizing electric power.

### Second Recording Process M11

The smart grid 10 is, as illustrated in FIG. 2, connected to a plurality of electricity storage devices 61 to 65. The second recording process m11 is a process of recording, of the electricity storage capacities of the electricity storage devices 61 to 65 connected to the smart grid 10, an allocated capacity that is allocated to a user in association with the user. Such a second recording process m11 makes it possible to control the electricity storage devices 61 to 65 that allow another user to use an available capacity of at least one of the electricity storage devices 61 to 65 connected to the smart grid 10 as their dedicated electricity storage capacity.

In this case, as illustrated in FIG. 8, the information processing apparatus 100 may be configured to record, of the electricity storage capacities of the electricity storage devices 61 to 65, an allocated capacity allocated to a user in association with the user. In the embodiment shown in FIG. 8, a data table prepared for the information processing apparatus 100 is configured to record allocated capacities that are allocated to respective users and user IDs identifying the users side-by-side. The allocated capacity allocated to a user can be used as an electricity storage capacity dedicated to the user, for example, in place of a home-use storage battery. The allocated capacity allocated to a user is a dedicated portion. Therefore, when a surplus of electric power arises for the user, the surplus electric power is discharged through the smart grid 10, so that the allocated capacity is inevitably considered as the one in which electricity has been stored when controlled. Such an allocated capacity allocated to the user may be automatically provided to the user when the user receives service through the smart grid 10, or may be separately provided as an option.

For example, in the embodiment shown in FIG. 2, a user A5 equipped with a large-scale electricity storage equipment 65 is able to store a sufficient amount of electric power in the large-scale electricity storage equipment 65. For this reason, the user A5 can provide a service of allocating an electricity storage capacity to other users to allow the other users to use the electricity storage capacity. For example, the user A4 that is a solar panel power generation operator may be able to store electric power any time by discharging the electric power generated by the solar panel 54. Therefore, the user A4 is not affected by the demand response from the aggregation coordinator 11 and is allowed to continue power generation with the solar panel 54. In addition, when a shortage of electric power occurs in the smart grid 10, the user A4 can supply electric power (i.e., sell electricity) to the smart grid 10 to thereby make a corresponding profit. Thus, with the second recording process m11, the solar panel power generation operator A4 is allowed to have a dedicated electricity storage capacity in the large-scale electricity storage equipment 65 of the user A5 to store a surplus of electric power. This enables the solar panel power generation operator A4 to fully utilize the power generation capability of the solar panels to generate electric power. The large-scale electricity storage equipment 65 may set a price for allocating an electricity storage capacity to a user.

### Sharing Setting Process M12

The sharing setting process m12 is a process of setting a portion of an electricity storage capacity of an electricity storage device connected to the smart grid to be available for sharing with a user connected to the smart grid. When employing such a sharing setting process m12, the sharing setting process m12 allows a portion of the electricity storage capacity of the electricity storage device to be used by an arbitrary user participating in the smart grid 10.

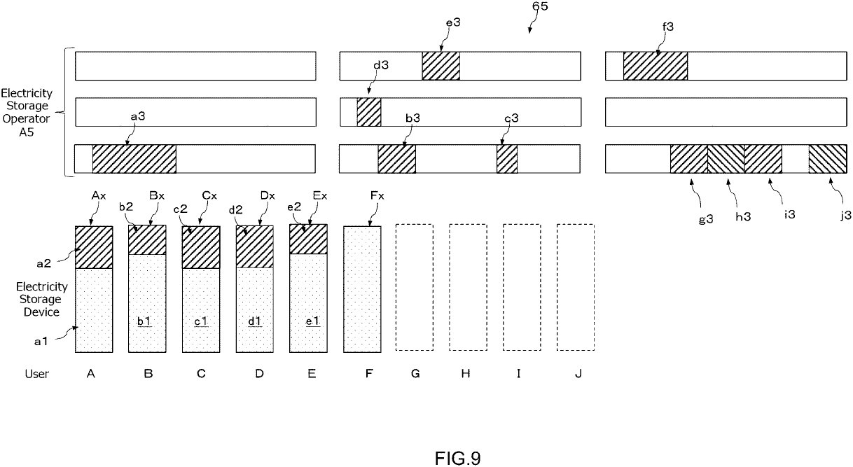

FIG. 9 is a schematic view illustrating a system that is implemented by a second recording process m11 and a sharing setting process m12. In the example schematically shown in FIG. 9, users A to F are provided with respective stationary-type electricity storage devices Ax to Fx each connected to the smart grid 10. Among them, the electricity storage device Ax of the user A is provided with an electricity storage capacity a1 that is used exclusively by the user A and an electricity storage capacity a2 that is made available to the participants of the smart grid 10 through the smart grid 10. The electricity storage capacity a2 is open to other users when it is free. In this case, when the electricity storage capacity a2 is free, the electricity storage capacity a2 can store the electric power generated by participants (other users) of the smart grid 10 through the smart grid 10. The electric power stored in the electricity storage capacity a2 may be stored in the information processing apparatus 100 as a virtual electrical storage capacity in association with the other user that has stored the generated electric power. The sharing setting process m12 may set a portion of or the whole of the capacity of the electricity storage device to be a capacity such as the electricity storage capacity a2. In the embodiment shown in FIG. 9, electricity storage devices Bx to Ex of users B to E are likewise provided with electricity storage capacities b1 to e1 that are exclusively used by the user A and electricity storage capacities b2 to e2 that are made available to participants of the smart grid 10 through the smart grid 10.

The information processing apparatus 100 may disclose the information of electricity storage capacities that are made available to participants of the smart grid 10 through the smart grid 10, on a dedicated web site or the like to the users participating the smart grid 10. Based on the disclosed information, the user participating the smart grid 10 may execute a process of storing generated electric power into the electricity storage capacity that is set for sharing. In such a process, the information processing apparatus 100 identifies the user ID in response to a control operation of the user and also causes an electrical equipment unit of the corresponding user identified by the user ID to discharge electric power to the smart grid 10. Then, the corresponding amount of electric power may be stored into the electricity storage capacity that is made available for sharing through the smart grid 10. Taking power transmission loss or the like into account, the amount of electric energy that is stored in the electricity storage capacity made available for sharing may be smaller than the amount of electric energy discharged from the electrical equipment unit of the user to the smart grid 10.

In the embodiment shown in FIG. 9, the electricity storage device Fx of the user F is not provided with an electricity storage capacity that is available to participants of the smart grid 10 through the smart grid 10. In this case, the user F is allowed to use the entire electricity storage device Fx exclusively on his/her own. Thus, the information processing apparatus 100 may be configured so that the user can selectively determine whether or not to set an electricity storage capacity available to participants of the smart grid 10. It is also possible that the information processing apparatus 100 may be configured to allow the user to obtain an incentive according to the use of the electricity storage capacity when setting an electricity storage capacity available to participants of the smart grid 10 through the smart grid 10.

In the example shown in FIG. 9, the users A to F are provided with dedicated capacities a3 to f3 in the electricity storage device 65 connected to the smart grid 10, which are rented from the electricity storage operator A5. In this case, the electricity storage operator A5 may record the allocated capacities of the electricity storage capacity of the electricity storage device 65 which are respectively allocated to the users A to F in association with the users A to F. This enables the users A to F to store surplus electric power into the electricity storage device 65 of the electricity storage operator A5 even when the capacities of their own electricity storage devices Ax to Fx are full. Then, the stored electric power may be managed by the information processing apparatus 100 as the virtual electrical storage capacity. As a result, the users A to F are allowed to receive electric power through the smart grid 10 as appropriate. On the other hand, users G to J do not possess their own electricity storage devices. However, the users G to J are provided with dedicated allocated capacities g3 to j3 in the electricity storage device 65 of the electricity storage operator A5. Therefore, although the users G to J do not possess their own electricity storage devices, the users G to J are able to store a surplus of electric power generated at their homes in the electricity storage device 65 of the electricity storage operator A5. Then, the stored electric power may be managed by the information processing apparatus 100 as the virtual electrical storage capacity. This allows the users G to J to receive the electric power generated at their homes through the smart grid 10 at any desired time and at any desired location. Such a process can be implemented by the second recording process m11.

In addition, blockchain technology, for example, may be used for the trade records of the depositing process m2, the withdrawal process m3, the transferring process m4, the purchasing process m5, the exchange process m8, and so forth of the virtual electrical storage capacity, the allocated capacity allocated to users, the monetary balance, the point balance, and the like in the information processing apparatus 100.

The system utilizing the virtual electrical storage capacity as described above records the amount of electric energy that each of the users can receive from the transmission grid 20 of the smart grid 10 in the information processing apparatus 100 as the virtual electrical storage capacity. In this case, a surplus of the electric power generated by the power generation devices 61 to 65 connected to the smart grid 10 is output to the smart grid 10 and is also recorded as the electric power that each of the users is allowed to receive from the transmission grid 20 of the smart grid 10 in association with the corresponding users. Irrespective of time and location, the user is allowed to receive electric power according to the virtual electrical storage capacity from the smart grid 10 at any desired time and at any desired location. When such a system of virtual electrical storage capacity is used by all the users participating in the smart grid 10, generated electric power are interchanged or rented between users in the user community connected by the smart grid 10. Moreover, the second recording process m11 and the sharing setting process m12 allow interchange of the electricity storage functions of the electricity storage devices 61 to 65 connected to the smart grid 10 between users. This makes it possible to fully utilize the functions of the power generation devices 51 to 55 and the electricity storage devices 61 to 65 connected to the smart grid 10. This is expected to allow the electric power generated in the user community to be consumed within the community more efficiently. It is possible to maximize self-generation and self-consumption.

As described previously, the virtual electrical storage capacity is defined as an amount of electric energy corresponding to the amount of electric energy that the user is allowed to receive from the smart grid 10. The virtual electrical storage capacity may also be considered as the amount of electric energy that is virtually stored in the smart grid 10. Herein, the amount of electric energy corresponding to the electric energy that is virtually stored in the smart grid 10 is referred to as “virtually-stored electric energy amount” as appropriate.

Among the types of energy sources handled in the smart grid 10, solar power generation, wind power generation, or the like cause fluctuations in the amount of power generated, depending on the weather. This means that, when the amount of power generated is small, the amount of power generated is in shortage relative to the electric power demand, so the user is forced to purchase electricity. On the other hand, when the amount of power generated is so large that the user’s own electricity storage device cannot store all the electric power, the user is forced to sell the surplus electric power. When electric power is generated by a renewable energy source, there are cases where the amount of power generated is large and where the amount of power generated is small, so the amount of generated power fluctuates.

The smart grid 10 includes, as illustrated in FIG. 2, a plurality of electricity storage devices 61 to 65. In this embodiment, the smart grid 10 includes user’s own electricity storage devices 61 to 64 as well as a large-scale electricity storage device 65 incorporating a large number of electricity storage devices, for example. The smart grid 10 is connected to these plurality of electricity storage devices 61 to 65 and is configured to be able to absorb the generated surplus electric power at any time to deal with increases or decreases of electric power demand in the smart grid 10.

### Information Processing Apparatus 140

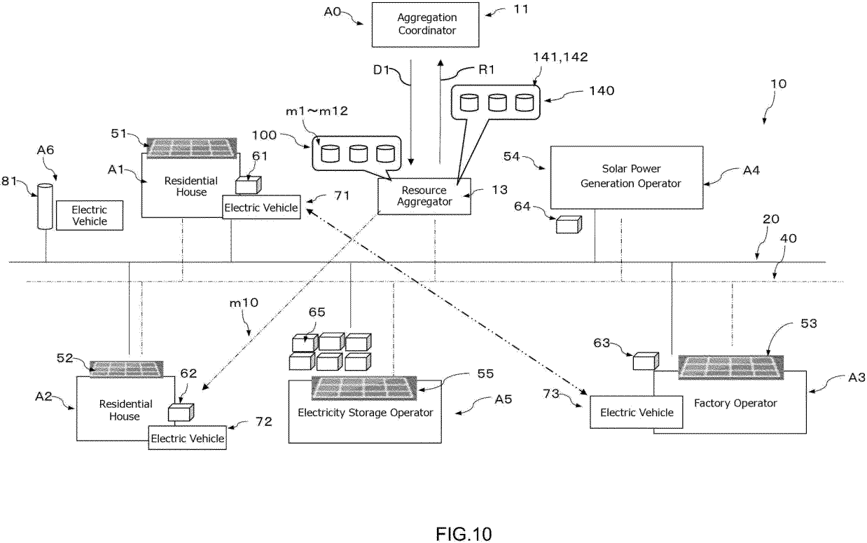

FIG. 10 is a schematic view illustrating an example of the configuration of the smart grid 10 including an information processing apparatus 140 disclosed herein. The information processing apparatus 140 disclosed herein includes a first memory storage unit 141 and a second memory storage unit 142. In this embodiment, the information processing apparatus 140 is incorporated in a cloud server of the resource aggregator 13 connected to the communication network 40 of the smart grid 10 as one of its functions. Each of various processes executed by the information processing apparatus 140 may be implemented as a processing module that executes predetermined operational processes according to a predetermined program. The information processing apparatus 140 may be an apparatus that is connected to the communication network 40 of the smart grid 10 to process information of the smart grid 10. From this viewpoint, the information processing apparatus 140 is not limited to the foregoing embodiment but may not be incorporated in the cloud server of the resource aggregator 13.

### First Memory Storage Unit 141

The first memory storage unit 141 is configured to record respective virtually-stored electric energy amounts of a plurality of users of the smart grid 10 in association with the plurality of users respectively. Herein, the first memory storage unit 141 is configured to record the virtually-stored electric energy amount of each one of the users to be a positive amount according to the amount of electric energy that is greater than 0 when the virtually-stored electric energy amount of the corresponding user is greater than 0. On the other hand, the first memory storage unit 141 is configured to record the virtually-stored electric energy amount of each one of the users to be a negative amount according to the amount of electric energy that is less than 0 when the virtually-stored electric energy amount of the user A1 is less than 0.

Herein, the information processing apparatus 140 is configured so that the virtually-stored electric energy amount of the one of the users stored in the first memory storage unit 141 is arithmetically increased according to an amount of electric energy that is output from an electrical equipment unit associated with the one of the users to the smart grid 10, and is arithmetically reduced according to an amount of electric energy that is output from the smart grid 10 to the electrical equipment unit associated with the one of the users.

For example, as illustrated in FIG. 10, the user A1 (residential house A1) is equipped with a solar panel 51, serving as the power generation device, and an electricity storage device 61. The electricity storage device 61 is able to store the electric power generated by the solar panel 51 serving as the power generation device. Among the electric power generated by the solar panel 51 serving as the power generation device, surplus electric power is output to the smart grid 10. In addition, the electric power stored in the electricity storage device 61 is also output to the smart grid 10 when appropriate. The user A1 may consume electric power by the electric power facilities installed in the household. At this time, the user A1 receives the supply of electric power from the smart grid 10 when appropriate, such as when the consumed electric power cannot be fully covered by the electric power generated by the solar panel 51 or the electric power stored in the electricity storage device 61.

In this case, the virtually-stored electric energy amount of the user A1 to be recorded in the first memory storage unit 141 may correspond to, for example, the amount of surplus electric energy stored in the electricity storage device 61. The virtually-stored electric energy amount of the user A1 that is recorded in the first memory storage unit 141 is arithmetically increased according to the amount of electric energy that is output to the smart grid 10 from the electrical equipment unit associated with the user A1. The amount of electric energy that is output to the smart grid 10 from the electrical equipment unit associated with the user A1 is obtained through, for example, the home energy management system (HEMS) associated with the user A1. Note that, when electric power is output to the smart grid 10 from the electrical equipment unit associated with the user A1, it is not stored in the electricity storage device 61 of the user A1. Herein, it is assumed that the amount of electric energy that is output to the smart grid 10 is virtually stored in the smart grid 10, so the virtually-stored electric energy amount of the user A1 recorded in the first memory storage unit 141 is arithmetically increased accordingly.

On the other hand, the virtually-stored electric energy amount of the user A1 recorded in the first memory storage unit 141 is arithmetically reduced according to the amount of electric energy that is output from the smart grid 10 to the electrical equipment unit associated with the user A1. The amount of electric energy that is output from the smart grid 10 to the electrical equipment unit associated with the user A1 is obtained through, for example, the home energy management system (HEMS) associated with the user A1. Note that when electric power is output from the smart grid 10 to the electrical equipment unit associated with the user A1, it does not necessarily cause the amount of electric energy stored in the electricity storage device 61 of the user A1 to decrease accordingly. Herein, it is assumed that the amount of electric energy that is output from the smart grid 10 to the electrical equipment unit associated with the user A1 is considered to reduce the amount of electric energy that has been virtually stored in the smart grid 10, so the virtually-stored electric energy amount of the user A1 recorded in the first memory storage unit 141 is arithmetically reduced accordingly.

Herein, when the virtually-stored electric energy amount of the user A1 is greater than 0, it is recorded in the first memory storage unit 141 as a positive amount according to the amount of electric energy that is greater than 0. On the other hand, when the virtually-stored electric energy amount of the user A1 is less than 0, it is recorded as a negative amount according to the amount of electric energy that is less than 0. When the virtually-stored electric energy amount of the user A1 is a positive amount, it is considered that the user A1 is storing electric power in the smart grid 10. When the virtually-stored electric energy amount of the user A1 is a negative amount, it is considered that the user A1 is borrowing electric power from the smart grid 10.

More specifically, the user A1 owns the solar panel 51 as a power generation device. The solar panel 51 generates electric power during daytime, and it may produce surplus electric power. Accordingly, when the surplus electric power is output to the smart grid 10, the virtually-stored electric energy amount of the user A1 becomes positive. In this case, the outputting of the surplus electric power by the user A1 to the smart grid 10 is not treated as a sale of electricity, but instead, the virtually-stored electric energy amount of the user A1 is increased. Thus, the outputting of the surplus electric power to the smart grid 10 is treated as storing of electric power in the smart grid 10.

On the other hand, the solar panel 51 does not generate electric power during night time. When a shortfall of electric power occurs during night time, the user A1 receives electric power from the smart grid 10 as appropriate. When this occurs, the virtually-stored electric energy amount of the user A1 is reduced according to the amount of electric energy that is output from the smart grid 10 to the electrical equipment unit associated with the user A1. In this case, the receipt of electric power by the user A1 from the smart grid 10 is not treated as purchase of electricity, but instead, the virtually-stored electric energy amount of the user A1 is reduced. Thus, the receipt of electric power from the smart grid 10 is treated as consumption of electric power that has been stored in the smart grid 10.

With such a process, when the surplus electric power originated from the electric power generated by self-generation is output to the smart grid 10, it may be treated as if the user A1 is storing electric power in the smart grid 10. That is, the virtually-stored electric energy amount of the user A1 increases when electric power is output to the smart grid 10 and decreases when electric power is received from the smart grid 10. When the user A1 supplies electric power to the smart grid 10, the virtually-stored electric energy amount increases, whereas when the user A1 receives electric power from the smart grid 10, the virtually-stored electric energy amount decreases. Such a process allows the user A1 to have the sense of storing the surplus electric power as the virtually-stored electric energy amount in the smart grid 10 and to have the sense of using the surplus electric power as the virtually-stored electric energy amount that has been stored in the smart grid 10 when the need arises. Moreover, the user A1 is allowed to handle surplus electric power in such a sense that when surplus electric power is generated by self-generation, he/she stores the surplus electric power in the surplus electric power, while when the electric power provided by self-generation is insufficient, he/she consumes the electric power stored in the smart grid 10. This allows the user A1 to feel as if all the electric power generated by self-generation is consumed for self-consumption.

In addition, the process as described above serves to reduce the instances that are treated as sales or purchases of electricity. Generally, the users’ mind is that the price of electricity at which they receive supply of electricity from the power utility company (i.e., the electricity purchase price) is set to be lower than the price at which the power utility company purchases surplus electric power (i.e., the electricity sales price). However, the above-described process allows the users to feel that the electric power generated by self-generation is used unwastefully for self-consumption because the users can store surplus electric power in the smart grid 10 and consume the electric power stored in the smart grid 10 when there is shortage of the electric power generated by self-generation. Moreover, it may also be more monetarily beneficial for the users than the cases where surplus electric power is treated as a sale of electricity each time.

The information processing apparatus 140 may be configured to appropriately limit the time at which the user A1 is allowed receive the electric power that is assumed to be stored as the virtually-stored electric energy amount in the smart grid 10. For example, the information processing apparatus 140 may be configured to limit the receipt of the electric power that is assumed to be stored as the virtually-stored electric energy amount in the smart grid 10 when the electric power demand in the smart grid 10 is excessively high. For example, the information processing apparatus 140 may be configured to allow the users to receive electric power by purchasing electricity from the smart grid 10 when the receipt of the electric power that is assumed to be stored as the virtually-stored electric energy amount in the smart grid 10 is limited. In this case, it is expected that the users’ motivation works toward reducing electric power consumption, so that the demand for electric power in the smart grid 10 can be reduced.

It is possible to match the amount of electric energy output to the smart grid 10 and the amount of electric energy to be arithmetically added to the virtually-stored electric energy amount of the user A1, in cases where surplus electric power is output to the smart grid 10. On the other hand, it is not always necessary to match the amount of electric energy output to the smart grid 10 and the amount of electric energy to be arithmetically added to the virtually-stored electric energy amount of the user A1. For example, it is possible that the amount of electric energy to be arithmetically added to the virtually-stored electric energy amount of the user A1 may be set less, or conversely greater, than the amount of electric energy that has been output to the smart grid 10.

For example, when a significant shortage of electric power occurs, or is predicted to occur, in the smart grid 10, the process may be performed such that the amount of electric energy to be arithmetically added to the virtually-stored electric energy amount of the user A1 may be made greater than the amount of electric energy that has been output to the smart grid 10. This heightens the user A1′s motivation to output surplus electric power to the smart grid 10. This process is also applied to other users than the user A1. It is expected that the surplus electric power that is actually output to the smart grid 10 increases for the entire smart grid 10, to thereby improve the balance between supply and demand of electric power in the smart grid 10.

For example, when a significant excess of electric power occurs, or is predicted to occur, in the smart grid 10, the process may be performed such that the amount of electric energy to be arithmetically added to the virtually-stored electric energy amount of the user A1 may be made less than the amount of electric energy that has been output to the smart grid 10. This heightens the user A1′s motivation to store surplus electric power into the user’s own electricity storage device 61, rather than outputting the surplus electric power to the smart grid 10. This process is also applied to other users than the user A1. It is expected that the surplus electric power that is actually output to the smart grid 10 decreases for the entire smart grid 10, to thereby improve the balance between supply and demand of electric power in the smart grid 10. The information processing apparatus 140 may be configured to notify the user participating in the smart grid 10 of how much the virtually-stored electric energy amount of the user is arithmetically increased relative to the amount of electric energy of the surplus electric power output by the user to the smart grid 10.

The smart grid information processing apparatus 140 is able to manage the virtually-stored electric energy amount of each user down to a negative state. The virtually-stored electric energy amount is arithmetically increased according to the amount of electric energy that is output from the electrical equipment unit associated with the user to the smart grid, and is arithmetically reduced according to the amount of electric energy that is output from the smart grid to the electrical equipment unit associated with the user. This enables the information processing apparatus 140 to manage the change in the virtually-stored electric energy amount of each user each time in terms of interchange of electricity between the smart grid and an electrical equipment unit associated with each user. The case where the virtually-stored electric energy amount of the user is negative means a state in which the user is temporarily provided with electric power from the smart grid 10, in other words, a state in which the user borrows electric power from the smart grid 10. That is, the smart grid information processing apparatus 140 is able to manage a state in which a user borrows electric power. The user can return the electric power to the smart grid 10 when surplus electric power is generated by self-generation or the like. That is, when the user outputs surplus electric power to the smart grid 10, the negative state of the virtually-stored electric energy amount of the user resolves.

The electric power temporarily supplied from the smart grid 10 to the user may be provided by the electric power stored by the electricity storage operator A5 equipped with a large-scale electricity storage facility 65. For example, the electricity storage operator A5 may supply and receive electric power to and from the smart grid 10, to thereby adjust the balance between supply and demand of electric power of each of the users participating in the smart grid 10. In that case, the information processing apparatus 140 may be configured so that the virtually-stored electric energy amount of each user is stored in the first memory storage unit 141 according to the receipt and supply of electric power of each user. That is, the balance between supply and demand of electric power in the smart grid 10 may be adjusted with cooperation of the electricity storage operator A5, and the virtually-stored electric energy amount of each user may be increased or decreased accordingly.

The smart grid 10 may be configured to adjust the balance between supply and demand of electric power appropriately by the electric power stored in the electricity storage devices 61 to 65 of the users participating in the smart grid 10. That is, the balance between supply and demand of electric power in the smart grid 10 is adjusted with cooperation of the participating users. In that case, the information processing apparatus 140 may be configured so that the virtually-stored electric energy amount of each user is stored in the first memory storage unit 141 according to the receipt and supply of electric power of each user.

By such information processing by the information processing apparatus 140, users who encounter a temporary shortage of electric power are allowed to be temporarily supplied with electric power through the smart grid 10, not to be processed each time by a sale or purchase of electricity. That is, each of the users is able to increase the virtually-stored electric energy amount of the user stored in the first memory storage unit 141 of the information processing apparatus 140 by outputting surplus electric power to the smart grid 10. Also, when a shortfall of electric power arises, each of the users is allowed to receive electric power from the smart grid 10 in exchange of a decrease of the virtually-stored electric energy amount of the user. Even when the virtually-stored electric energy amount of the user falls to a negative amount, the user is allowed to receive electric power from the smart grid 10. The user can return electric power to the smart grid 10 when surplus electric power is generated later to resolve the negative amount of the virtually-stored electric energy amount.

Thus, the smart grid information processing apparatus 140 records the virtually-stored electric energy amount of each user down to a negative state. Specifically, the information processing apparatus 140 is configured to record the virtually-stored electric energy amount of each user to be a negative amount according to the amount of electric energy that is less than 0 when the virtually-stored electric energy amount of the user is less than 0. Because the virtually-stored electric energy amount is recorded as a negative amount, the user is allowed to borrow electric power from the smart grid 10 when there is a shortage of electric power, and to return the electric power after surplus electric power arises. This improves user convenience in using electric power for the users utilizing renewable energy. Thus, the user is allowed to receive a temporary supply of necessary electric power from the smart grid 10 when there is a shortage of electric power, without being processed each time by a sale or purchase of electricity.

### Second Memory Storage Unit 142

The second memory storage unit 142 is configured to store data representing one of electricity storage devices 61 to 65 connected to the smart grid 10 that is usable by one of the users so that the one of electricity storage devices 61 to 65 is associated with the one of the users. The virtually-stored electric energy amount of a user stored in the first memory storage unit 141 is configured to be arithmetically increased according to an amount of electric energy stored from the smart grid 10 into the one of the electricity storage devices associated with the user, and to be arithmetically reduced according to an amount of electric energy that is output from the one of the electricity storage devices associated with the user to the smart grid 10. In this case, the virtually-stored electric energy amount is arithmetically increased when the user stores electric power in the electricity storage device, and it is arithmetically reduced when the user outputs the electric power stored in the electricity storage device to the smart grid 10.

For example, as illustrated in FIG. 9, a large-sized electricity storage device 65 may be provided by the electricity storage operator A5 in the smart grid 10. The users A to F can borrow respective exclusively usable capacities a3 to f3 from the electricity storage device 65 of the electricity storage operator A5, which is connected to the smart grid 10. The electricity storage devices that are usable by the users are not limited to the users’ own electricity storage devices 61 to 64, but may include allocated capacities that are allocated to the users A to F from the electricity storage capacity of the electricity storage device 65. The second memory storage unit 142 is configured to store data representing one of electricity storage devices 61 to 65 connected to the smart grid 10 that is usable by one of the users so that the one of electricity storage devices 61 to 65 is associated with the one of the users. That is, in the embodiment shown in FIG. 9, the users’ own electricity storage devices 61 to 64 and the respective allocated capacities that are allocated to the users A to F from the electricity storage capacity of the electricity storage device 65 of the electricity storage operator A5 may correspond to the electricity storage devices that are usable by the users A to F. The electric power stored in the users’ own electricity storage devices 61 to 64 and the respective allocated capacities that are allocated to the users A to F from the electricity storage capacity of the electricity storage device 65 of the electricity storage operator A5 may be consumed at a time convenient for the users.

The virtually-stored electric energy amount of the one of the users stored in the first memory storage unit 141 is configured to be arithmetically increased according to an amount of electric energy stored in the one of the electricity storage devices associated with the one of the users, and to be arithmetically reduced according to an amount of electric energy that is output from the one of the electricity storage devices associated with the one of the users. That is, the virtually-stored electric energy amount of a user is arithmetically increased or arithmetically reduced according to the amount of stored electric energy stored in the users’ own electricity storage devices 61 to 64 and the allocated capacities that are allocated to the users A to F from the electricity storage capacity of the electricity storage device 65 of the electricity storage operator A5.

For example, in the embodiment shown in FIG. 10, the virtually-stored electric energy amount of the user A1 may be configured to be arithmetically increased when surplus electric power of the user A1 is stored in the user’s own electricity storage device 61. In addition, the virtually-stored electric energy amount of the user A1 may be configured to be arithmetically reduced when electric power is output from the user A1′s own electricity storage device 61 to the smart grid 10. The virtually-stored electric energy amount of the user A1 may also be configured to be arithmetically increased when the user A1 purchases electric power from the solar power generation operator A4 and stores electric power in the electricity storage capacity allocated to the user A1 from the electricity storage capacity of the electricity storage device 65 through the smart grid 10 as well. In addition, the virtually-stored electric energy amount of the user A1 may be configured to be arithmetically reduced according to the amount of the output electric energy when electric power is output from the electricity storage capacity that is allocated to the user A1 to the smart grid 10. Thus, the virtually-stored electric energy amount of the user A1 stored in the first memory storage unit 141 may be configured to reflect the electric power stored in the electricity storage device that is usable by the user A1 in the smart grid 10.

In this case, the virtually-stored electric energy amount of the user A1 stored in the first memory storage unit 141 may indicate the value of the electric power stored by the user A1 in the electricity storage devices 61 to 65 connected to the smart grid 10. Also when electric power is transferred from the electricity storage capacity allocated to the user A1 (residential house A1) to the electricity storage capacity allocated to the user A2 (residential house A2) in the electricity storage device 65, the virtually-stored electric energy amount of the user A1 stored in the first memory storage unit 141 is reduced and the virtually-stored electric energy amount of the user A2 is increased. Thus, the virtually-stored electric energy amount of a user stored in the first memory storage unit 141 may be configured to reflect the electric power stored in the electricity storage device that is usable by the user. Specifically, this information processing apparatus 140 is configured so that the virtually-stored electric energy amount of a user stored in the first memory storage unit 140 is configured to be arithmetically increased according to the amount of electric energy stored in an electricity storage device associated with the user, and to be arithmetically reduced according to the amount of electric energy that is output from the electricity storage device associated with the user. It is considered that the greater the amount of electric energy stored in the electricity storage device usable by the user in the smart grid 10, the higher the credibility of the user regarding the supply and demand of electric power in the smart grid 10, which is reflected in the virtually-stored electric energy amount of the user.

Although the virtually-stored electric energy amount of the user A1 stored in the first memory storage unit 141 may be configured to reflect the electric power stored in the electricity storage device that is usable by the user A1 in the smart grid 10, it may not be necessary to involve the process of transferring the electric power that is actually stored. In other words, it is not necessary to actually transfer the electric power in the electricity storage device 65. By changing the information of the virtually-stored electric energy amounts of the users A1 and A2 stored in the first memory storage unit 141, the electric power can be treated as if it is transferred from the electricity storage capacity allocated to the user A1 to the electricity storage capacity allocated to the user A2 in the electricity storage device 65. In this way, the virtually-stored electric energy amount of the user A1 stored in the first memory storage unit 141 may indicate the value of the electric power stored by the user A1 in the electricity storage devices 61 to 65 connected to the smart grid 10. In this case, by means of information processing, the user A1 is allowed to lend the electric power stored in the smart grid 10 to the user A2 and the user A2 is allowed to return the electric power stored in the smart grid 10 to the user A1,

In the information processing apparatus 140, a negative permissible amount may be predetermined regarding the virtually-stored electric energy amount of a user stored in the first memory storage unit 141. The information processing apparatus 140 may be configured to execute an electricity purchasing process according to an amount of electric energy that is output from the smart grid 10 to the electrical equipment unit associated with the user when the virtually-stored electric energy amount of the user falls beyond the negative permissible amount. This resolves the condition in which the user is allowed to receive supply of electric power from the smart grid 10 unlimitedly even when the virtually-stored electric energy amount of the user is negative.

The negative permissible amount may be determined according to an amount of electric energy that is output from the electrical equipment unit associated with the user to the smart grid for a predetermined period. For example, the negative permissible amount may be determined based on an actual value, such as an amount of electric energy that is output from the electrical equipment unit associated with the user to the smart grid within a fixed period, such as the most recent one week (7 days). The predetermined period for calculating the negative permissible amount is determined as appropriate. For example, the predetermined period may be the most recent 3 days, the most recent 2 weeks, or the most recent 1 month. The predetermined period may also be last week, last month, or the same month of the previous year. It is also possible that the actual value for a predetermined period may be evaluated by the average value per one day over the predetermined period.

For example, the actual value for the most recent one week may be evaluated by the average value per one day for the most recent one week, based on the actual value of the amount of electric energy that is output from the electrical equipment unit associated with the user to the smart grid for the most recent one week. By setting an appropriate period for the predetermined period, it is possible to appropriately evaluate the amount of electric energy that a user is able to output to the smart grid 10. In addition, by evaluating the actual value for the predetermined period with the actual value per one day, it is possible to reduce adverse effects due to the variation in the amount of power generated resulting from changes of weather in a short period of time. Note that how the predetermined period should be determined may be decided taking changes in electric power consumption into consideration, such as conditions of the power generation device and the electricity storage device and changes in family members. This makes it possible to predict the amount of electric energy that is output from the electrical equipment unit associated with the user to the smart grid with higher accuracy. The negative permissible amount is determined according to the amount of electric energy that is output from the electrical equipment unit associated with the user to the smart grid 10 for a predetermined period, whereby it is possible to appropriately set a limit on the amount of electric energy that the smart grid 10 is able to provide to the user.

The negative permissible amount may also be determined according to a predicted value of the amount of electric energy that is output from the electrical equipment unit associated with the user to the smart grid 10 for a predetermined period. In other words, the negative permissible amount may also be determined based on a future prediction of the amount of electric energy that is output from the electrical equipment unit associated with the user to the smart grid 10. For example, when the user owns a power generation device including solar power generation, the amount of power generated may be estimated based on weather forecasts. In this case, when it is predicted that the amount of power generated will be great, the negative permissible amount for the virtually-stored electric energy amount of the user may be set greater accordingly. In this case as well, it is possible to appropriately set a limit on the amount of electric energy that the smart grid 10 is able to provide to the user.

In addition, a positive permissible amount may be predetermined for the virtually-stored electric energy amount of the user. The information processing apparatus 140 may be configured to execute an electricity selling process according to an amount of electric energy that is output from the electrical equipment unit associated with the one of the users to the smart grid when the virtually-stored electric energy amount of the one of the users exceeds the positive permissible amount. This resolves the condition in which the virtually-stored electric energy amount of the user is unlimitedly accumulated. This provides an upper limit on the virtually-stored electric energy amount of the user according to the electric power that can be supplied by the smart grid 10, so that electric power can be supplied stably to each user according to the virtually-stored electric energy amount. Thus, provision of upper limit on the virtually-stored electric energy amount of the user ensures credibility of the virtually-stored electric energy amount.

In this case, the positive permissible amount may be determined according to the storable capacity of one of the electricity storage devices connected to the smart grid 10 that is usable by the user. For example, when the user owns an electricity storage device connected to the smart grid 10, the positive permissible amount of the user may be determined according to the storable capacity of that electricity storage device. In this case, it is possible that: storable capacity of the electricity storage device = positive permissible amount of the user. It is also possible to set an appropriate mathematical function so that the positive permissible amount of the user can be determined based on the storable capacity of the electricity storage device. For example, the positive permissible amount of the user may be obtained by multiplying the storable capacity of the electricity storage device by an appropriate coefficient. It is also possible to obtain the positive permissible amount of the user by adding or subtracting an appropriate amount to or from the storable capacity of the electricity storage device.

For example, it is possible to obtain the positive permissible amount by the equation: positive permissible amount = (basic virtually-stored electric energy amount) + (capacity of electricity storage device). For example, assuming that the basic virtually-stored electric energy amount of the user is 3 kW·h and the user owns an electricity storage device with a capacity of 5kWh, the positive permissible amount of the user is calculated as: 3 kW·h + 5 kWh = 8 kWh.

When the user borrows an exclusively usable capacity from the electricity storage device 65 of the electricity storage operator A5, the upper limit of the virtually-stored electric energy amount according to the electricity storage capability of the user in the smart grid 10 may be increased according to the borrowed capacity. Accordingly, when the user wants to increase the upper limit (i.e., the positive permissible amount) of the virtually-stored electric energy amount, the user is able to increase the positive permissible amount of the virtually-stored electric energy amount by, for example, borrowing an exclusively usable capacity from the electricity storage device 65 of the electricity storage operator A5. The greater the positive permissible amount of the virtually-stored electric energy amount, the less likely the surplus electric power is processed as a sale of electricity, so the user is able to store more electric power in the smart grid 10 as the virtually-stored electric energy amount.

Hereinbelow, specific examples of the processes performed by the information processing apparatus 140 will be described in more detail.

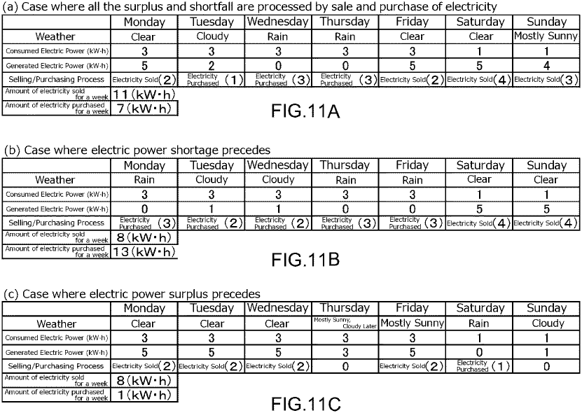

FIGS. 11A-C to 14A-C each show a table illustrating an example of simulation data illustrating the transition of electric power supply and demand of a user. Herein, in the simulation settings, the consumed power is 3 kWh on each day of Monday to Friday, and 1 kWh on each of Saturday and Sunday. The electric power is generated by a solar panel. The amount of electric energy generated is 5 kWh on a clear day, 4 kWh on a mostly sunny day, 4 kWh on a mostly sunny and then cloudy day, 2 kWh on a cloudy day, and 0 kWh on a rainy day. The sales and purchase of electricity on each day are as shown in the drawings. The numerals in parentheses show amounts of electric energy that has been sold or purchased, expressed in units of kWh.

In FIGS. 11A-C, no electricity storage device is provided, and the supply and demand for electric power of the user are processed by sales and purchases of electricity.

Case (a) shows a pattern in which the weather changes over a week from Monday through Sunday as follows: clear, cloudy, rain, rain, clear, clear, and mostly sunny. In this pattern, the amounts of electricity sold and purchased for the week are 11 kWh and 7 kWh, respectively.

Case (B) shows a pattern in which the weather changes over a week from Monday through Sunday as follows: rain, cloudy, cloudy, rain, rain, clear, clear, and clear. In this pattern, shortage of electric power precedes, and the amounts of electricity sold and purchased for the week is 8 kWh and 13 kWh, respectively.

Case (c) shows a pattern in which the weather changes over a week from Monday through Sunday as follows: clear, clear, clear, mostly sunny but cloudy later, clear, rain, and cloudy. In this pattern, the state in which there is a surplus electric power precedes, and the amounts of electricity sold and purchased for the week are 8 kWh and 1 kWh, respectively.

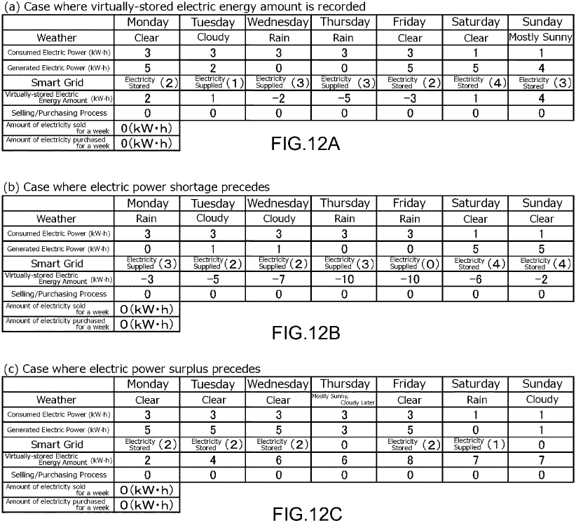

FIGS. 12A-C show the cases where the virtually-stored electric energy amount is recorded by the information processing apparatus 140 and, even when an electric power shortage occurs, electric power is provided from the smart grid 10. The weather variation patterns in cases (a) to (c) are the same as those in FIGS. 11A-C.

In any of cases (a) to (c), the virtually-stored electric energy amount turns to be negative when an electric power shortage occurs, in exchange for receiving a loan of electric power from the smart grid 10. When surplus electric power arises, the user returns electric power to the smart grid 10, and the balance of the virtually-stored electric energy amount improves. For example, in the pattern in which an electric power shortage precedes as in case (b), there are days on which the virtually-stored electric energy amount reaches -10 kWh. The user is allowed to receive provision of electric power from the smart grid 10. Therefore, the amount of electricity purchased for the week is 0 kWh. In addition, in the pattern in which electric power excess precedes as in case (c), there are days on which the virtually-stored electric energy amount reaches +8 kWh. However, because the surplus electric power is not sold but is stored as the virtually-stored electric energy amount, the user is allowed to prepare for a later electric power shortage. Note that when there is an electricity storage device, the user can store electric power in the user’s own electricity storage device. In addition, the virtually-stored electric energy amount of the one of the users stored in the first memory storage unit 141 may be configured to be arithmetically increased according to an amount of electric energy stored in the one of the electricity storage devices associated with the one of the users, and to be arithmetically reduced according to an amount of electric energy that is output from the one of the electricity storage devices associated with the one of the users. In this case, because there are electricity storage devices, the virtually-stored electric energy amount increases accordingly when a surplus electric power arises. As a result, the user is unlikely to experience an electric power shortage, and the amount of electric power received from the smart grid 10 decreases as a whole.

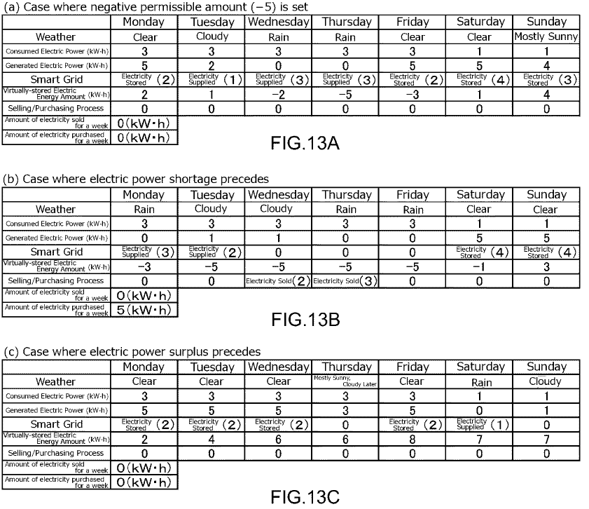

In FIGS. 13A-C, the negative permissible amount of the virtually-stored electric energy amount is set to -5 kWh, in addition to the settings of FIGS. 12A-C. In this case, the information processing apparatus 140 is controlled so as to execute an electricity purchasing process according to the amount of electric energy that is output from the smart grid 10 to the electrical equipment unit associated with the user when the virtually-stored electric energy amount of the user falls beyond the negative permissible amount (-5 kWh).

In the pattern of case (a), the virtually-stored electric energy amount does not fall beyond the negative permissible amount (-5 kWh). For this reason, the user can receive provision of electric power from the smart grid 10 in the event of electric power shortage. In the pattern in which an electric power shortage precedes as in case (b), the virtually-stored electric energy amount falls beyond -5 kWh. In this case, the user is unable to receive provision of electric power from the smart grid 10 for the portion that is beyond the negative permissible amount, so an electricity purchasing process occurs. Therefore, in case (b), the amount of electricity purchased for the week is 5 kWh. However, the amount of electric energy processed as a purchase of electricity can be made smaller than that in the case where the entire shortfall of electric power is compensated for by an electricity purchasing process in the event of electric power shortage, as in the case of FIGS. 11A-C. Moreover, from the standpoint of an operator operating the smart grid 10, for example, the resource aggregator 13, the temporary supply of electric power is not performed excessively. This serves for a stable operation of the smart grid 10.

The negative permissible amount may be determined according to the amount of electric energy that is output from the electrical equipment unit associated with the user to the smart grid 10 for a predetermined period. For example, in the example shown in FIGS. 13A-C, the virtually-stored electric energy amount reaches +8 kWh, when electric power excess precedes as in case (c). For this reason, the negative permissible amount of the virtually-stored electric energy amount of the user may be set to about -8 kWh. Thus, the negative permissible amount may be determined according to the amount of electric energy that is output from the electrical equipment unit associated with the user to the smart grid 10 for a predetermined period. Also, the negative permissible amount may be determined according to a predicted value of the amount of electric energy that is output from the electrical equipment unit associated with the user to the smart grid 10 for a predetermined period. In this case, the negative permissible amount is set appropriately based on the capability of storing the virtually-stored electric energy amount of the user. As a result, it is possible to increase the amount of electric power temporarily supplied from the smart grid 10 while maintaining a stable operation of the smart grid 10, so that the processes of sales and purchases of electricity can be reduced.

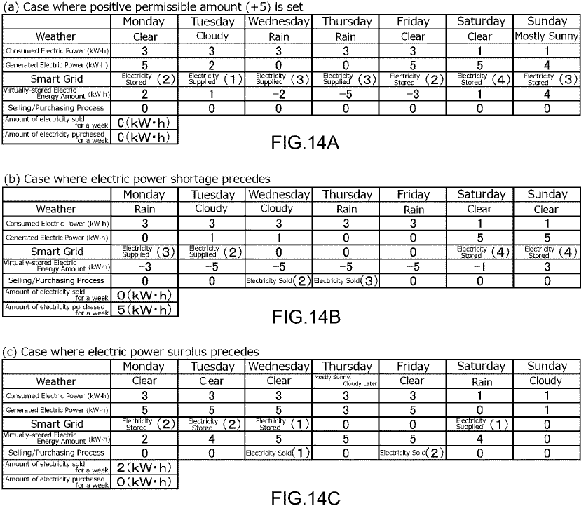

In FIGS. 14A-C, the positive permissible amount of the virtually-stored electric energy amount is set to +5 kWh, in addition to the settings of FIGS. 13A-C. In this case, the information processing apparatus 140 is controlled so as to execute an electricity selling process according to the amount of electric energy that is output from the smart grid 10 to the electrical equipment unit associated with the user when the virtually-stored electric energy amount of the user exceeds the positive permissible amount (+5 kWh).

In this case, for example, as in case (c), when the virtually-stored electric energy amount exceeds +5 kWh, the surplus electric power is processed as a sale of electricity. Therefore, the virtually-stored electric energy amount does not increase beyond +5 kWh. Because the surplus electric power is processed as a sale of electricity when the virtually-stored electric energy amount exceeds +5 kWh, the amount of electricity sold for this week is 2 kWh. However, the amount of electric energy processed as a sale of electricity can be made smaller than that in the case where all the surplus electric power is processed as a sale of electricity, as in the case of FIGS. 11A-C. Moreover, from the standpoint of an operator operating the smart grid 10, for example, the resource aggregator 13, the virtually-stored electric energy amount does not increase unlimitedly, reducing the amount of electric energy to be prepared for supplying to the user. Thus, the positive permissible amount is set appropriately. As a result, it is possible to reduce the processes of sales and purchases of electricity while appropriately maintaining a stable operation of the smart grid 10.

The positive permissible amount may be determined according to the storable capacity of one of the electricity storage devices connected to the smart grid 10 that is usable by the user. For example, when the user owns an electrical storage device, the user is able to store electric power in the electricity storage device, so the virtually-stored electric energy amount can be increased by storing electric power in the user’s own electricity storage device. Even when the positive permissible amount for such a user is set greater accordingly, the smart grid 10 is operated stably.

Furthermore, the first memory storage unit 140 may be configured to record lending and borrowing of the virtually-stored electric energy amount between a plurality of users of the smart grid 10. For example, the user A may borrow the virtually-stored electric energy amount from the user B. In this case, the information processing apparatus 140 may record the virtually-stored electric energy amount that the user A borrows from the user B. The information processing apparatus 140 may also record the virtually-stored electric energy amount that the user B lends to the user A. In this way, the information processing apparatus 140 may record lending and borrowing of the virtually-stored electric energy amount between a plurality of users of the smart grid 10 mutually. When a user experiences a shortage of virtually-stored electric energy amount, the user may borrow an appropriate amount of virtually-stored electric energy from another user.

For example, when a user A1 stores electric power in a usable electricity storage device and processes a large virtually-stored electric energy amount, the user A1 may become a lender of virtually-stored electric energy amount while another user A2 may become a borrower of virtually-stored electric energy amount. For example, when the other user A2 needs electric power, the other user A2 may borrow a virtually-stored electric energy amount from the user A1. The information processing apparatus 140 records lending and borrowing of virtually-stored electric energy amount between the user A1 and the user A2, and it also arithmetically reduces the virtually-stored electric energy amount of the user A1 recorded in the first memory storage unit 141 and arithmetically increases the virtually-stored electric energy amount of the user A2. As a result, the user A2 is allowed to receive electric power from the smart grid 10, using the virtually-stored electric energy amount that has been borrowed from the user A1. Thereafter, the user A2 may generate electric power with the user’s own power generation device, and then, when the user A2 has stored a sufficient virtually-stored electric energy amount, the user A2 may return the virtually-stored electric energy amount to the user A1. At that time, the information processing apparatus 140 updates the record of lending and borrowing of virtually-stored electric energy amount between the user A1 and the user A2, and it also arithmetically reduces the virtually-stored electric energy amount of the user A2 recorded in the first memory storage unit 141 and arithmetically increases the virtually-stored electric energy amount of the user A1. This enables the user A2 to procure electric power in the event of electric power shortage without purchasing electricity each time. In this case, users are allowed to procure electric power by borrowing and returning electric power. As a result, it is possible to reduce the monetary cost for procuring electric power.

Note that, when lending and borrowing the virtually-stored electric energy amount, electric power does not need to be actually transferred from the electricity storage device that is usable by the user A1 to the electricity storage device that is usable by the user A2. It is merely necessary to reduce the virtually-stored electric energy amount of the user A1 stored in the first memory storage unit 141 and increase the virtually-stored electric energy amount of the user A2. Then, the virtually-stored electric energy amount of the user A2 is reduced according to the amount of electric energy that the user A2 has received from the smart grid 10. At that time, electric power may be output from the electricity storage device usable by the user A1 to the smart grid 10 to keep the balance between the virtually-stored electric energy amount of the user A1 and the amount of electric energy stored in the electricity storage device usable by the user A1. Thus, the information processing apparatus 140 is able to record the virtually-stored electric energy amount of each of the users. By appropriately increasing and decreasing the virtually-stored electric energy amount of each user, the electric power stored by a user can be provided, lent, or returned to another user. The users are allowed to receive necessary electric power from the smart grid 10 without purchasing of electricity each time.

In this case, the electricity storage operator A5 equipped with a large-scale electricity storage device may function as a lender that lends the virtually-stored electric energy amount to a plurality of users of the smart grid 10. The information processing apparatus 140 may be configured to set an interest for lending and borrowing of the virtually-stored electric energy amount. By setting an interest for lending and borrowing of the virtually-stored electric energy amount, the lender side is able to receive benefits obtained by lending the virtually-stored electric energy amount.

Assuming that an interest rate of 10% is set for lending and borrowing of virtually-stored electric energy amount and, for example, the user A1 lends a virtually-stored electric energy amount of 1 kWh to the user A2, a virtually-stored electric energy amount to be returned is set to 1.1 kWh when the user A2 returns it to the user A1, for example. Thus, the process may be set so that the borrower returns the virtually-stored electric energy amount to the lender with the interest added. It is also possible that the interest rate may be set appropriately between users.

Referring to FIG. 10, the notion of lending and borrowing of virtually-stored electric energy amount will be explained. For example, in FIG. 10, lending and borrowing of the virtually-stored electric energy amount occur between the user A3 (factory A3) and the user A1 (residential house A1) or the user A4 (power generation operator A4). The user A3 is a factory operator. On days when the factory operates, the user A3 tends to experience an electric power shortage, and the virtually-stored electric energy amount is likely to be negative. However, on days when the factory does not operate, electric power is generated by a solar panel 53 attached to the factory, and surplus electric power may be produced. On the other hand, the user A1 works at a factory during daytime on weekdays, so he/she consumes relatively less electric power at home. For this reason, surplus electric power is likely to be produced. In contrast, the user A1 is at home on weekends, so he/she tends to consume more electric power at home and electric power is likely to be short. In addition, the user A4 is a solar power generation operator, which is likely to produce surplus electric power.

In this case, the user A3 may borrow a virtually-stored electric energy amount from the user A1 or the user A4 during daytime on days when the factory operates, to receive temporary supply of electric power from the smart grid 10. For the user A1 and the user A4, their virtually-stored electric energy amounts decrease because their virtually-stored electric energy amounts are lent to the user A3. Then, the virtually-stored electric energy amount borrowed by the user A3 allows the user A3 to receive temporary supply of electric power from the smart grid 10. This enables the user A3 to procure electric power without an electricity selling process. On days when the factory does not operate, the user A3 may obtain a virtually-stored electric energy amount by outputting his/her surplus electric power to the smart grid 10, to return the borrowed virtually-stored electric energy amount to the user A1 or the user A4. At this time, when an interest is set for the virtually-stored electric energy amount, the user A3 may return the virtually-stored electric energy amount with the interest added. Thus, when an electric power shortage occurs, the user A3 can borrow a virtually-stored electric energy amount from another user, utilizing surplus electric power that will be obtained at a later date. This enables the user A3 to substantially consume the renewable energy generated at the user’s own house.

The information processing apparatus 140 may be configured to record data of the virtually-stored electric energy amounts of the users in a blockchain. In this case, the information processing apparatus 140 is configured to record, for example, data of arithmetic increases and decreases of the virtually-stored electric energy amounts and data of lending and borrowing of the virtually-stored electric energy amounts between the users, in the blockchain, as the data of the virtually-stored electric energy amounts of the users. This enables a series of transaction records in the information processing apparatus 140 to be recorded as verifiable information by the blockchain. When the data of the virtually-stored electric energy amounts of the users are recorded in a blockchain, the data of arithmetic increases and decreases of the virtually-stored electric energy amounts of the users of the information processing apparatus 140 and the data of lending and borrowing of the virtually-stored electric energy amounts between the users may be put together as one transaction and recorded in the blockchain. When the data of the virtually-stored electric energy amounts of the users are recorded in a blockchain, the data of arithmetic increases and decreases of the virtually-stored electric energy amounts and the data of lending and borrowing of the virtually-stored electric energy amounts between the users are prevented from being tampered with, so it is possible to construct a highly reliable system.

As described above, the information processing apparatus 140 proposed herein enables users to use surplus electric power obtained by self-generation at any time the users wish to use, even after the surplus electric power has been output to the smart grid 10. The accuracy of weather forecast has been improved year by year, so, for example, the amount of insolation or the amount of electric power generated within 24 hours can approximately be predicted. For this reason, in power generation utilizing solar panels, future occurrence of surplus electric power can be predicted with high accuracy. Because the information processing apparatus 140 can record the virtually-stored electric energy amount as a negative amount according to the amount of electric energy that is less than 0, it is possible to construct a system that allows the users to use the surplus electric power that is expected to be produced in the future in advance at a time they wish to use. This system reduces the processes that necessitate monetary transactions in electricity trades, such as sales of electricity and purchases of electricity, and increases convenience and versatility of electric power. Moreover, the virtually-stored electric energy amount may be lent or sold to other users, for example, in a similar way to the previously described virtual electrical storage capacity, so it can have a value as an asset that has exchangeability. The information processing apparatus 140 that manages the virtually-stored electric energy amount allows an administrator who manages the information processing apparatus 140, for example, the resource aggregator 13, with a position like a manager, to provide a service that enables users to deposit surplus electric power, to be temporarily supplied with electric power for an electric power shortage of the users, and to lend and borrow electric power between the users.

The processes disclosed herein may be combined with any existing electricity selling processes or electricity purchasing processes. When that is the case, the processes may be configured so that users are able to select whether surplus electric power is processed by an existing electricity selling process or processed as a virtually-stored electric energy amount. For example, there may be cases where the electricity sales price is set relatively high under limited conditions, such as when the amount of power generated by a power utility company is insufficient. In such cases, users may choose to sell surplus electric power willingly. Thus, the above-described processes allow users to have more choices for handling surplus electric power. The virtually-stored electric energy amount may be sold as appropriate. For example, when the electricity sales price is high or when users wish to exchange the virtually-stored electric energy amount into money, users may sell electricity based on the virtually-stored electric energy amount. In this case, at the time of selling electricity, the virtually-stored electric energy amount may be regarded as the right to receive supply of electric power from the smart grid 10, and the virtually-stored electric energy amount corresponding to the amount of electric energy to be sold may be considered as having been processed by an electricity selling process and may be eliminated, instead of obtaining money. On the other hand, when the electricity purchase price from a power utility company is low and when future electric power consumption is expected to increase, users may purchase electricity actively and store electricity purchase price in the users’ own electricity storage devices or the like to increase the virtually-stored electric energy amount. Thus, users may adjust their virtually-stored electric energy amounts by selling and purchasing electric power at arbitrary time.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

What is claimed is:

1. An information processing apparatus for a smart grid, comprising:
a first memory storage unit recording respective virtually-stored electric energy amounts of a plurality of users of the smart grid, the virtually-stored electric energy amounts being respectively associated with the plurality of users, wherein:
the first memory storage unit is configured to record the virtually-stored electric energy amount of one of the users as a positive amount according to an amount of electric energy that is greater than 0 when the virtually-stored electric energy amount of the one of the users is greater than 0, and to record the virtually-stored electric energy amount of the one of the users as a negative amount according to an amount of electric energy that is less than 0 when the virtually-stored electric energy amount of the one of the users is less than 0; and
the virtually-stored electric energy amount of the one of the users stored in the first memory storage unit is configured to be arithmetically increased according to an amount of electric energy that is output from an electrical equipment unit associated with the one of the users to the smart grid and to be arithmetically reduced according to an amount of electric energy that is output from the smart grid to the electrical equipment unit associated with the one of the users.

2. The information processing apparatus according to claim 1, further comprising:
a second memory storage unit storing data representing at least one of electricity storage devices connected to the smart grid, the at least one of electricity storage devices being usable by the one of the plurality of users and associated with the one of the plurality of users; and
the virtually-stored electric energy amount of the one of the users stored in the first memory storage unit is configured to be arithmetically increased according to an amount of electric energy stored in the one of the electricity storage devices associated with the one of the users, and to be arithmetically reduced according to an amount of electric energy that is output from the one of the electricity storage devices associated with the one of the users.

3. The information processing apparatus according to claim 1, wherein:
a negative permissible amount is predetermined for the virtually-stored electric energy amount of the one of the users; and
the information processing apparatus is configured to execute an electricity purchasing process according to an amount of electric energy that is output from the smart grid to the electrical equipment unit associated with the one of the users when the virtually-stored electric energy amount of the one of the users falls beyond the negative permissible amount.

4. The information processing apparatus according to claim 3, wherein the negative permissible amount is determined according to an amount of electric energy that is output from the electrical equipment unit associated with the one of the users to the smart grid for a predetermined period.

5. The information processing apparatus according to claim 3, wherein the negative permissible amount is determined according to a predicted value of amount of electric energy that is output from the electrical equipment unit associated with the one of the users to the smart grid for a predetermined period.

6. The information processing apparatus according to claim 1, wherein:
a positive permissible amount is predetermined for the virtually-stored electric energy amount of the one of the users; and
the information processing apparatus is configured to execute an electricity selling process according to an amount of electric energy that is output from the electrical equipment unit associated with the one of the users to the smart grid when the virtually-stored electric energy amount of the one of the users exceeds the positive permissible amount.

7. The information processing apparatus according to claim 6, wherein the positive permissible amount is determined according to a storable capacity of one of the electricity storage devices connected to the smart grid, the one of the electricity storage devices being usable by the one of the users.

8. The information processing apparatus according to claim 1, being configured to record lending and borrowing of the virtually-stored electric energy amount between the plurality of users of the smart grid.

9. The information processing apparatus according to claim 8, being configured to set an interest for the lending and borrowing of the virtually-stored electric energy amount.

10. The information processing apparatus according to claim 1, being configured to record data of the virtually-stored electric energy amounts of the plurality of users in a blockchain.
